(19) United States
(12) Patent Application Publication
(10) Pub. No.: US 2025/0125456 A1
(43) Pub. Date: Apr. 17, 2025

(54) OUTER PACKAGE MATERIAL FOR POWER STORAGE DEVICES, METHOD FOR PRODUCING SAME, AND POWER STORAGE DEVICE

(71) Applicant: DAI NIPPON PRINTING CO., LTD., Tokyo (JP)

(72) Inventors: Toshiki KATOKU, Tokyo (JP); Atsushi NAGAI, Tokyo (JP); Takayuki KOMAI, Tokyo (JP)

(73) Assignee: DAI NIPPON PRINTING CO., LTD., Tokyo (JP)

(21) Appl. No.: 18/683,853

(22) PCT Filed: Aug. 10, 2022
(86) PCT No.: PCT/JP2022/030543

§ 371 Date: Feb. 15, 2024

(30) Foreign Application Priority Data
Aug. 18, 2021 (JP) 2021-133287

(51) Int. Cl. H01M 50/126; H01M 50/105; H01M 50/119; H01M 50/121; H01M 50/131

(52) U.S. Cl. CPC H01M 50/126; H01M 50/105; H01M 50/119; H01M 50/121; H01M 50/131

(57) ABSTRACT

An outer package material for power storage devices, the outer package material being configured from a multilayer body that sequentially comprises at least a base material layer, an adhesive layer, a barrier layer and a thermally fusible resin layer in this order, wherein: the base material layer comprises a polyamide layer; the polyamide layer has a thermal shrinkage ratio of 2.5% or less at 180° C. in the machine direction; and the adhesive layer has a glass transition temperature (Tg) of 100° C. to 139° C.

### TECHNICAL FIELD

The present disclosure relates to an exterior material for electrical storage devices, a method for manufacturing the exterior material for electrical storage devices, and an electrical storage device.

### BACKGROUND ART

Various types of electrical storage devices have been developed heretofore, and in every electrical storage device, an exterior material is an essential member for sealing electrical storage device elements such as an electrode and an electrolyte. Metallic exterior materials have been often used heretofore as exterior materials for electrical storage devices.

On the other hand, in recent years, electrical storage devices have been required to be diversified in shape and to be thinned and lightened with improvement of performance of electric cars, hybrid electric cars, personal computers, cameras, mobile phones and so on. However, metallic exterior material for electrical storage devices that have often been heretofore used have the disadvantage that it is difficult to keep up with diversification in shape, and there is a limit on weight reduction.

Thus, heretofore a film-shaped laminate with a base material layer, a barrier layer, an adhesive layer and a heat-sealable resin layer laminated in this order has been proposed as an exterior material for electrical storage devices which is easily processed into diversified shapes and is capable of achieving thickness reduction and weight reduction (see, for example, Patent Document 1).

In such an exterior material for electrical storage devices, generally, a concave portion is formed by cold molding, electrical storage device elements such as an electrode and an electrolytic solution are disposed in a space formed by the concave portion, and heat-sealable resin layers are heat-sealed to obtain an electrical storage device with electrical storage device elements housed in the exterior material for electrical storage devices.

### PRIOR ART DOCUMENT

### Patent Document

Patent Document 1: Japanese Patent Laid-open Publication No. 2008-287971

### SUMMARY OF THE INVENTION

### Problems to be Solved by the Invention

An electrical storage device may be used in a high-temperature environment, and if an electrical storage device with an exterior material for electrical storage devices which includes a film-shaped laminate as described above is placed in a high-temperature environment, delamination is likely to occur between a base material layer located on the outer side of the exterior material for electrical storage devices and a barrier layer. When a thermal runaway of an electrical storage device occurs (i.e., when the temperature of the electrical storage device increases), the temperature of the electrical storage device may become as high as, for example, about 120° C., leading to a particularly high possibility that delamination occurs between the base material layer and the barrier layer. If an exterior material for electrical storage devices is delaminated between a base material layer and a barrier layer, there is a problem that the mechanical strength of the exterior material for electrical storage devices decreases, so that it is difficult to maintain the shape of an electrical storage device.

An exterior material for electrical storage devices which includes a film-shaped laminate as described above is manufactured as a long laminated film with each layer being continuously laminated while running in a machine direction (MD) in manufacturing of the exterior material. Further, the laminated film is wound, stored and distributed as a roll, and used for manufacturing an electrical storage device. During manufacturing of the electrical storage device, the laminated film is unwound from the roll, cut into a size suitable for the size of the electrical storage device, and subjected to the steps of cold molding, housing of an electrical storage device element.

However, there is a problem that large warpage occurs in an exterior material for electrical storage devices due to cutting of the exterior material for electrical storage devices. It is also required to suppress warpage of an exterior material for electrical storage devices due to cutting because occurrence of large warpage in the exterior material for exterior material for electrical storage devices reduces productivity of an electrical storage device.

A main object of the present disclosure is to provide an exterior material for electrical storage devices which includes a polyamide layer as a base material layer, in which delamination between the polyamide layer and a barrier layer in the case of placement in a high-temperature environment (at about 120° C.) is suppressed, and warpage due to cutting is suppressed.

### Means for Solving the Problems

The inventors of the present disclosure have extensively conducted studies for solving the above-described problems. As a result, the present inventors have found that in an exterior material for electrical storage devices which includes a laminate including at least a base material layer, an adhesive agent layer, a barrier layer and a heat-sealable resin layer in this order, the base material layer including a polyamide layer, the polyamide layer having a heat shrinkage ratio of 2.5% or less at 180° C. in a machine direction, the adhesive agent layer having a glass transition temperature (Tg) of 100° C. or higher and 139° C. or lower, delamination between the polyamide layer and the barrier layer in the case of placement in a high-temperature environment (at about 120° C.) is suppressed, and warpage due to cutting is suppressed.

The present disclosure has been completed by further conducting studies on the basis the above-mentioned findings. That is, the present disclosure provides an invention of an aspect as described below.

An exterior material for electrical storage devices, including a laminate including at least a base material layer, an adhesive agent layer, a barrier layer and a heat-sealable resin layer in this order,
the base material layer including a polyamide layer,
the polyamide layer having a heat shrinkage ratio of 2.5% or less at 180° C. in a machine direction,
the adhesive agent layer having a glass transition temperature (Tg) of 100° C. or higher and 139° C. or lower.

### Advantages of the Invention

According to the present disclosure, it is possible to provide an exterior material for electrical storage devices which includes a polyamide layer as a base material layer, in which delamination between the polyamide layer and a barrier layer in the case of placement in a high-temperature environment (at about 120° C.) is suppressed, and warpage due to cutting is suppressed. According to the present disclosure, it is also possible to provide a method for manufacturing an exterior material for electrical storage devices, and an electrical storage device.

### BRIEF DESCRIPTION OF THE DRAWINGS

FIG. 1 is a schematic diagram showing an example of a cross-sectional structure of an exterior material for electrical storage devices according to the present disclosure.

FIG. 2 is a schematic diagram showing an example of a cross-sectional structure of an exterior material for electrical storage devices according to the present disclosure.

FIG. 3 is a schematic diagram showing an example of a cross-sectional structure of an exterior material for electrical storage devices according to the present disclosure.

FIG. 4 is a schematic diagram for illustrating a method for housing an electrical storage device element in a packaging formed from an exterior material for electrical storage devices according to the present disclosure.

FIG. 5 is a schematic diagram for illustrating a method for measuring a magnitude of warpage of an exterior material for electrical storage devices due to cutting.

### EMBODIMENTS OF THE INVENTION

An exterior material for electrical storage devices according to the present disclosure includes a laminate including at least a base material layer, an adhesive agent layer, a barrier layer and a heat-sealable resin layer in this order, the base material layer including a polyamide layer, the polyamide layer having a heat shrinkage ratio of 2.5% or less at 180° C. in a machine direction, the adhesive agent layer having a glass transition temperature (Tg) of 100° C. or higher and 139° C. or lower. In the exterior material for electrical storage devices according to the present disclosure, which has a configuration mentioned above, delamination between the polyamide layer and the barrier layer in the case of placement in a high-temperature environment (at about 120° C.) is suppressed, and warpage due to cutting is suppressed.

Hereinafter, the exterior material for electrical storage devices according to the present disclosure will be described in detail. In the present disclosure, a numerical range indicated by the term “A to B” means “A or more” and “B or less”. For example, the expression of “2 to 15 mm” means 2 mm or more and 15 mm or less.

In the exterior material for electrical storage devices, Machine Direction (MD) and Transverse Direction (TD) in the process for manufacturing thereof can be discriminated from each other for the barrier layer 3 described later. For example, when the barrier layer 3 includes a metal foil such as an aluminum alloy foil or a stainless steel foil, linear streaks called rolling indentations are formed on the surface of the metal foil in the rolling direction (RD) of the metal foil. Since the rolling indentations extend along the rolling direction, the rolling direction of the metal foil can be known by observing the surface of the metal foil. In the process for manufacturing of the laminate, the MD of the laminate and the RD of the metal foil normally coincides with each other, and therefore by observing the surface of the metal foil of the laminate to identify the rolling direction (RD) of the metal foil, the MD of the laminate can be identified. Since the TD of the laminate is perpendicular to the MD of the laminate, the TD of the laminate can be identified.

If the MD of the exterior material for electrical storage devices cannot be identified by the rolling indentations of the metal foil such as an aluminum alloy foil or a stainless steel foil, the MD can be identified by the following method. Examples of the method for identifying the MD of the exterior material for electrical storage devices include a method in which a cross-section of the heat-sealable resin layer of the exterior material for electrical storage devices is observed with an electron microscope to examine a sea-island structure. In the method, the direction parallel to a cross-section in which the average of the diameters of the island shapes in a direction perpendicular to the thickness direction of the heat-sealable resin layer is maximum can be determined as MD. Specifically, a cross-section in the length direction of the heat-sealable resin layer and cross-sections (a total of 10 cross-sections) at angular intervals of 10 degrees from a direction parallel to the cross-section in the length direction to a direction perpendicular to the cross-section in the length direction are observed with an electron microscope photograph to examine sea-island structures. Next, in each cross-section, the shape of each island is observed. For the shape of each island, the linear distance between the leftmost end in a direction perpendicular to the thickness direction of the heat-sealable resin layer and the rightmost end in the perpendicular direction is taken as a diameter y. In each cross-section, the average of the top 20 diameters y in descending order of the diameter y of the island shape is calculated. The direction parallel to a cross-section having the largest average of the diameters y of the island shapes is determined as MD.

### 1. Laminated Structure and Characteristics of Exterior Material for Electrical Storage Devices

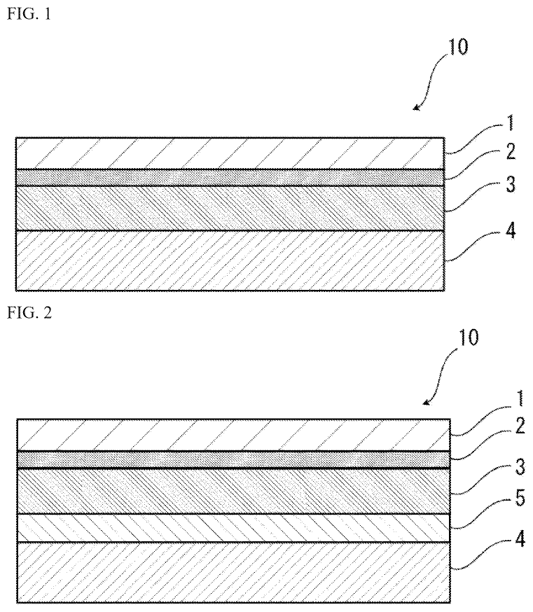

As shown in, for example, FIGS. 1 to 3, an exterior material 10 for electrical storage devices according to the present disclosure includes a laminate including at least a base material layer 1, an adhesive agent layer 2, a barrier layer 3 and a heat-sealable resin layer 4 in this order. In the exterior material 10 for electrical storage devices, the base material layer 1 is on the outermost layer side, and the heat-sealable resin layer 4 is an innermost layer. In construction of an electrical storage device using the exterior material 10 for electrical storage devices and an electrical storage device element, the electrical storage device elements are put in a space formed by heat-sealing the peripheral portions of heat-sealable resin layers 4 of the exterior material 10 for electrical storage devices which face each other. In the laminate forming the exterior material 10 for electrical storage devices according to the present disclosure, the heat-sealable resin layer 4 is on the inner side with respect to the barrier layer 3, and the base material layer 1 is on the outer side with respect to the barrier layer 3.

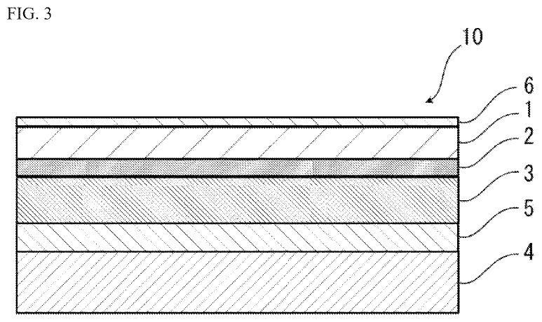

As shown in, for example, FIGS. 2 and 3, the exterior material 10 for electrical storage devices may have an adhesive layer 5 between the barrier layer 3 and the heat-sealable resin layer 4 if necessary for the purpose of, for example, improving bondability between these layers. As shown in FIG. 3, a surface coating layer 6 or the like may be provided on the outside of the base material layer 1 (on a side opposite to the heat-sealable resin layer 4 side) if necessary.

The thickness of the laminate forming the exterior material 10 for electrical storage devices is not particularly limited, and is, for example, about 190 μm or less, preferably about 180 μm or less, about 155 μm or less, or about 120 μm or less, from the viewpoint of cost reduction, energy density improvement, and the like. The thickness of the laminate forming the exterior material 10 for electrical storage devices is preferably about 35 μm or more, about 45 μm or more, or about 60 μm or more, from the viewpoint of maintaining the function of an exterior material for electrical storage devices, which is protection of an electrical storage device element. The thickness of the laminate forming the exterior material 10 for electrical storage devices is preferably in the range of, for example, about 35 to 190 μm, about 35 to 180 μm, about 35 to 155 μm, about 35 to 120 μm, about 45 to 190 μm, about 45 to 180 μm, about 45 to 155 μm, about 45 to 120 μm, about 60 to 190 μm, about 60 to 180 μm, about 60 to 155 μm, or about 60 to 120 μm, and in particular, the thickness is preferably about 60 to 155 μm for reducing the weight and the thickness of the electrical storage device, and preferably about 155 to 190 μm for improving moldability.

In the exterior material 10 for electrical storage devices, the ratio of the total thickness of the base material layer 1, the adhesive agent layer 2, the barrier layer 3, the adhesive layer 5 provided if necessary, the heat-sealable resin layer 4, and the surface coating layer 6 provided if necessary to the thickness (total thickness) of the laminate forming the exterior material 10 for electrical storage devices is preferably 90% or more, more preferably 95% or more, still more preferably 98% or more. As a specific example, when the exterior material 10 for electrical storage devices according to the present disclosure includes the base material layer 1, the adhesive agent layer 2, the barrier layer 3, the adhesive layer 5 and the heat-sealable resin layer 4, the ratio of the total thickness of these layers to the thickness (total thickness) of the laminate forming the exterior material 10 for electrical storage devices is preferably 90% or more, more preferably 95% or more, still more preferably 98% or more.

From the viewpoint of suitably exhibiting the effect of the invention of the present disclosure, the lamination strength of the exterior material for electrical storage devices according to the present disclosure in an environment at 25° C. is preferably 6.0 N or more, more preferably 7.0 N or more, still more preferably 8.0 N or more in <Lamination strength between polyamide layer and barrier layer (in environment at 25° C. and 120° C.)> in examples described later. The lamination strength at 25° C. is, for example, 12.0 N or less. From the same viewpoint, the lamination strength in an environment at 120° C. is preferably 3.9 N or more, more preferably 4.0 N or more, still more preferably 4.5 N or more. The lamination strength in an environment at 120° C. is, for example, 8.0 N or less.

From the viewpoint of suitably exhibiting the effect of the invention of the present disclosure, the warpage height in the exterior material for electrical storage devices according to the present disclosure is preferably 2.4 mm or less, more preferably 2.0 mm or less, still more preferably 1.5 mm or less in the machine direction, and preferably 23.0 mm or less in the transverse direction, in <Warpage height> in examples described later.

From the viewpoint of suitably exhibiting the effect of the invention of the present disclosure, the limit molding depth of the exterior material for electrical storage devices according to the present disclosure is preferably about 5.0 mm or more, more preferably 6.0 mm or more, still more preferably 7.0 mm or more in <Moldability> in examples described later. The limit molding depth is, for example, 10.0 mm or less.

### 2. Layers Forming Exterior Material for Electrical Storage Devices

### [Base Material Layer 1]

In the present disclosure, the base material layer 1 is a layer provided for the purpose of, for example, exhibiting a function as a base material of the exterior material for electrical storage devices. The base material layer 1 is located on the outer layer side of the exterior material for electrical storage devices.

The base material layer 1 includes a polyamide layer. The polyamide layer means a layer formed of polyamide. That is, it is preferable that the polyamide layer contains polyamide as a main component. Here, the main component means that the content ratio of polyamide to the resin components contained in the polyamide layer is, for example, 50 mass % or more, preferably 60 mass % or more, more preferably 70 mass % or more, still more preferably 80 mass % or more, still more preferably 90 mass % or more, still more preferably 95 mass % or more, still more preferably 98 mass % or more, still more preferably 99 mass % or more. The polyamide layer may contain additives described later in addition to polyamide as a resin.

Specific examples of the polyamide include polyamides such as aliphatic polyamides such as nylon 6, nylon 66, nylon 610, nylon 12, nylon 46, and copolymers of nylon 6 and nylon 66; hexamethylenediamine-isophthalic acid-terephthalic acid copolymerization polyamides containing a structural unit derived from terephthalic acid and/or isophthalic acid, such as nylon 6I, nylon 6T, nylon 6IT and nylon 616T (I denotes isophthalic acid and T denotes terephthalic acid), and polyamides containing aromatics, such as polyamide MXD6 (polymethaxylylene adipamide); alicyclic polyamides such as polyamide PACM6 (polybis(4-aminocyclohexyl) methaneadipamide; polyamides copolymerized with a lactam component or an isocyanate component such as 4,4′-diphenylmethane-diisocyanate, and polyester amide copolymers and polyether ester amide copolymers as copolymers of a copolymerization polyamide and a polyester or a polyalkylene ether glycol; and copolymers thereof. These polyamides may be used alone, or may be used in combination of two or more thereof.

The polyamide layer may be, for example, a resin film formed of polyamide, or may be formed by applying polyamide. The polyamide film may be an unstretched film or a stretched film. Examples of the stretched film include uniaxially stretched films and biaxially stretched films, and biaxially stretched films are preferable. Specifically, the polyamide layer is formed preferably of a stretched nylon film, more preferably of a biaxially stretched nylon film. Examples of the stretching method for forming a biaxially stretched film include a sequential biaxial stretching method, an inflation method, and a simultaneous biaxial stretching method. Examples of the method for applying a resin include a roll coating method, a gravure coating method and an extrusion coating method.

In the present disclosure, the polyamide layer has a heat shrinkage ratio of 2.5% or less at 180° C. in the machine direction. For setting the heat shrinkage ratio of the polyamide layer at 180° C. in the machine direction to 2.5% or less, for example, it is desirable that the polyamide film be manufactured as a stretched film (preferably a biaxially stretched film) with the draw ratio adjusted to be low. Heretofore, the draw ratio has been increased for enhancing moldability when a stretched polyamide film is used for the base material layer of the exterior material for electrical storage devices. On the other hand, in the present disclosure, a polyamide layer whose heat shrinkage ratio is equal to or smaller than a predetermined value at 180° C. in the machine direction and an adhesive agent layer 2 described later whose glass transition temperature (Tg) is set within a specific range are combined to suppress delamination between the polyamide layer and the barrier layer in the case of placement in a high-temperature environment (at about 120° C.), and suppress warpage of an exterior material for electrical storage devices due to cutting. Therefore, in the present disclosure, it is preferable that the draw ratio is set low to reduce the heat shrinkage ratio of the polyamide layer at 180° C. in the machine direction unlike a stretched polyamide film that is typically used for a conventional exterior material for electrical storage devices. As the polyamide film having a heat shrinkage ratio of 2.5% or less at 180° C. in the machine direction, for example, one having a heat shrinkage ratio of 2.5% or less as measured at 180° C. in the machine direction, among commercially available polyamide films adjusted to have a low draw ratio, can be selected and used as a polyamide layer.

The heat shrinkage ratio of the polyamide layer at 180° C. in the machine direction is only required to be 2.5% or less, and from the viewpoint of more suitably exhibiting the effect of the present disclosure, the heat shrinkage ratio is preferably 1.9% or less, more preferably 1.4% or less, still more preferably 1.2% or less. The heat shrinkage ratio is, for example, 0.5% or more.

From the viewpoint of more suitably exhibiting the effect of the invention of the present disclosure, the heat shrinkage ratio of the polyamide layer at 180° C. in the transverse direction is preferably 3.5% or less, more preferably 3.0% or less, still more preferably 2.5% or less. The heat shrinkage ratio is, for example, 1.0% or more.

The method for measuring the heat shrinkage ratios of the polyamide layer at 180° C. in the machine direction and the transverse direction is as follows.

### <Heat Shrinkage Ratio of Polyamide Layer at 180° C.>

The polyamide layer is cut into a size of 10 cm in the machine direction (MD)×10 cm in the transverse direction (TD) to obtain a test piece. The test piece is heated in an oven at 180° C. for 30 minutes, and the size change ratio of the test piece in each of the machine direction (MD) and the transverse direction (TD) (two directions orthogonal to each other) before and after heating is taken as a heat shrinkage ratio at 180° C., and determined from the following equation.

Heat shrinkage ratio(size change ratio) at 180° C.=[(X−Y)/X]×100

X is a size before heating in the oven, and Y is a size after heating in the oven.

From the viewpoint of more suitably exhibiting the effect of the invention of the present disclosure, the hot water shrinkage ratio of the polyamide layer at 95° C. in the machine direction is preferably 1.9% or less, more preferably 1.4% or less, still more preferably 1.2% or less. The hot water shrinkage ratio is, for example, 0.5% or more. From the same viewpoint, the hot water shrinkage ratio of the polyamide layer at 95° C. in the transverse direction is preferably 3.5% or less, more preferably 3.0% or less, still more preferably 2.5% or less. The hot water shrinkage ratio is, for example, 1.0% or more.

The base material layer 1 may further include, in addition to the polyamide layer, another layer. The material for forming the other layer is not particularly limited as long as it has a function as a base material, i.e., at least insulation quality. The other layer can be formed using, for example, a resin, and the resin may contain additives described later.

When the other layer is formed of a resin, the other layer may be a resin film formed of a resin or may be formed by applying a resin like the polyamide layer described above. The resin film may be an unstretched film or a stretched film. Examples of the stretched film include uniaxially stretched films and biaxially stretched films, and biaxially stretched films are preferable. Examples of the stretching method for forming a biaxially stretched film include a sequential biaxial stretching method, an inflation method, and a simultaneous biaxial stretching method. Examples of the method for applying a resin include a roll coating method, a gravure coating method and an extrusion coating method.

Examples of the resin that forms the other layer include resins such as polyester, polyolefin, epoxy resin, acrylic resin, fluororesin, polyurethane, silicone resin and phenol resin, and modified products of these resins. The resin that forms the other layer may be a copolymer of these resins or a modified product of the copolymer. Further, a mixture of these resins may be used.

Of these resins, polyester is preferable as a resin that form the other layer.

Specific examples of the polyester include polyethylene terephthalate, polybutylene terephthalate, polyethylene naphthalate, polybutylene naphthalate, polyethylene isophthalate, and copolyesters. Examples of the copolyester include copolyesters having ethylene terephthalate as a main repeating unit. Specific examples thereof include copolymer polyesters that are polymerized with ethylene isophthalate and include ethylene terephthalate as a main repeating unit (hereinafter, abbreviated as follows after polyethylene (terephthalate/isophthalate)), polyethylene (terephthalate/adipate), polyethylene (terephthalate/sodium sulfoisophthalate), polyethylene (terephthalate/sodium isophthalate), polyethylene (terephthalate/phenyl-dicarboxylate) and polyethylene (terephthalate/decane dicarboxylate). These polyesters may be used alone, or may be used in combination of two or more thereof.

The other layer contains preferably at least one of a polyester film and a polyolefin film, preferably at least one of a stretched polyester film and a stretched polyolefin film, still more preferably at least one of a stretched polyethylene terephthalate film, a stretched polybutylene terephthalate film and a stretched polypropylene film, even more preferably at least one of a biaxially stretched polyethylene terephthalate film, a biaxially stretched polybutylene terephthalate film and a biaxially stretched polypropylene film.

The base material layer 1 may be a single layer, or may include two or more layers. When the base material layer 1 is a single layer, the base material layer 1 includes a polyamide layer. When the base material layer 1 includes two or more layers, the base material layer 1 may be a laminate obtained by laminating a polyamide layer and another layer with an adhesive or the like, or a resin film laminate obtained by co-extruding resins to form a polyamide layer and another layer. The resin film laminate obtained by co-extruding resins to form two or more layers may be used as the base material layer 1 in an unstretched state, or may be uniaxially stretched or biaxially stretched and used as the base material layer 1.

Specific examples of the resin film laminate with two or more layers in the base material layer 1 include laminates of a polyester film and a nylon film, and nylon film laminates with two or more layers. Laminates of a stretched nylon film and a stretched polyester film, and stretched nylon film laminates with two or more layers are preferable. For example, when the base material layer 1 is a resin film laminate with two layers, the base material layer 1 is preferably a laminate of a polyamide resin film and a polyamide resin film, or a laminate of a polyester resin film and a polyamide resin film, more preferably a laminate of a nylon film and a nylon film, or a laminate of a polyethylene terephthalate film and a nylon film. When the base material layer 1 includes two or more polyamide layers, it is only required that at least one polyamide layer have a heat shrinkage ratio of 2.5% or less at 180° C. in the machine direction, and it is preferable that the heat shrinkage ratios of all the polyamide layers at 180° C. are 2.5% or less. Since the polyester resin is hardly discolored even in the case where for example, an electrolytic solution is deposited on the surface, it is preferable that the polyester resin film is located at the outermost layer of the base material layer 1 when the base material layer 1 is a resin film laminate with two or more layers.

When the base material layer 1 is a resin film laminate with two or more layers, the two or more resin films may be laminated with an adhesive agent interposed therebetween. Specific examples of the preferred adhesive include the same adhesives as those exemplified for the adhesive agent layer 2 described later. For example, the base material layer 1 is preferably a laminate of a polyester layer, an adhesive agent layer and a polyamide layer in this order from the outer side (side opposite to the barrier layer 3 side), in which the glass transition temperature (Tg) of the adhesive agent layer bonding the polyester layer and the polyamide layer is 100° C. or higher and 139° C. or lower. In this case, the adhesive agent layer bonding the polyamide layer and the polyester layer and the adhesive agent layer 2 bonding the polyamide layer and the barrier layer 3 both have a glass transition temperature (Tg) of 100° C. or higher and 139° C. or lower.

The method for laminating a resin film having two or more layers is not particularly limited, and a known method can be employed. Examples thereof include a dry lamination method, a sand lamination method, an extrusion lamination method and a thermal lamination method, and a dry lamination method is preferable. When the resin film is laminated by a dry lamination method, it is preferable to use a polyurethane adhesive as the adhesive. Here, the thickness of the adhesive is, for example, about 2 to 5 μm. In addition, the lamination may be performed with an anchor coat layer formed on the resin film. Examples of the anchor coat layer include the same adhesives as those exemplified for the adhesive agent layer 2 described later. Here, the thickness of the anchor coat layer is, for example, about 0.01 to 1.0 μm.

In the base material layer 1, additives such as a slipping agent, a flame retardant, an antiblocking agent, an antioxidant, a light stabilizer, a tackifier and an antistatic agent may be present on the surface of the polyamide layer or another layer and/or inside the polyamide layer or another layer. The additives may be used alone, or may be used in combination of two or more thereof.

In the base material layer 1, an easily adhesive layer may be formed on at least one surface of the polyamide layer or another layer. For example, when an easily adhesive layer forms a surface of the polyamide layer on the barrier layer 3 side, adhesion between the polyamide layer and the adhesive agent layer 2 can be enhanced. For example, in the case where the base material layer 1 further includes a polyester layer, adhesion between the polyamide layer and the polyester layer can be enhanced when an easily adhesive layer forms an outer surface (a surface opposite to the barrier layer 3 side) of the polyamide layer.

Examples of the resin for forming the easily adhesive layer include various synthetic resins such as polyvinylidene chloride, vinylidene chloride-vinyl chloride copolymers, polyolefins, acid-modified polyolefins, polyester, epoxy resins, phenol resins, fluororesins, cellulose esters, polyurethane, acrylic resins, and polyamide. Among them, polyurethane, polyester and acrylic resins are preferable.

The easily adhesive layer may contain an additive if necessary. Examples of the additive include the same additives as those exemplified for a surface coating layer 6 described later. The content and the particle size of the additive are appropriately adjusted to the thickness of the easily adhesive layer.

The thickness of the easily adhesive layer is not particularly limited as long as the above-described function as an easily adhesive layer is performed, and it is, for example, about 0.01 to 0.40 μm, preferably about 0.01 to 0.30 μm, still more preferably about 0.1 to 0.30 μm. When the thickness is 0.01 μm or more, a layer having a uniform thickness can be formed on the base material layer 1. As a result, when the easily adhesive layer is provided on the outermost side, uniform printed characters can be formed without occurrence of unevenness in printed characteristic of the exterior material for electrical storage devices according to the present disclosure, or uniform moldability can be obtained, and when there is a layer adjacent to the easily adhesive layer, uniform adhesion can be obtained.

In the present disclosure, it is preferable that a slipping agent is present on the surface of the base material layer 1 from the viewpoint of enhancing the moldability of the exterior material for electrical storage devices. The slipping agent is not particularly limited, and examples thereon include amide-based slipping agents, silicone-based slipping agents, and fluorine-based slipping agents, with amide-based slipping agents being preferable. Specific examples of the amide-based slipping agent include saturated fatty acid amides, unsaturated fatty acid amides, substituted amides, methylol amides, saturated fatty acid bisamides, unsaturated fatty acid bisamides, fatty acid ester amides, and aromatic bisamides. Specific examples of the saturated fatty acid amide include lauric acid amide, palmitic acid amide, stearic acid amide, behenic acid amide, and hydroxystearic acid amide. Specific examples of unsaturated fatty acid amide include oleic acid amide and erucic acid amide. Specific examples of the substituted amide include N-oleylpalmitic acid amide, N-stearyl stearic acid amide, N-stearyl oleic acid amide, N-oleyl stearic acid amide, and N-stearyl erucic acid amide. Specific examples of the methylolamide include methylolstearic acid amide. Specific examples of the saturated fatty acid bisamide include methylenebisstearic acid amide, ethylenebiscapric acid amide, ethylenebislauric acid amide, ethylenebisstearic acid amide, ethylenebishydroxystearic acid amide, ethylenebisbehenic acid amide, hexamethylenebisstearic acid amide, hexamethylenehydroxystearic acid amide, N,N′-distearyl adipic acid amide, and N,N′-distearyl sebacic acid amide. Specific examples of the unsaturated fatty acid bisamide include ethylenebisoleic acid amide, ethylenebiserucic acid amide, hexamethylenebisoleic acid amide, N,N′-dioleyladipic acid amide, and N,N′-dioleylsebacic acid amide. Specific examples of the fatty acid ester amide include stearoamideethyl stearate. Specific examples of the aromatic bisamide include m-xylylenebisstearic acid amide, m-xylylenebishydroxystearic acid amide, and N,N′-distearylisophthalic acid amide. The slipping agents may be used alone, or may be used in combination of two or more thereof.

When the slipping agent is present on the surface of the base material layer 1, the amount of the slipping agent present is not particularly limited, and is preferably about 3 mg/m² or more, more preferably about 4 to 15 mg/m², still more preferably about 5 to 14 mg/m².

The slipping agent present on the surface of the base material layer 1 may be one obtained by exuding the slipping agent contained in the resin forming the base material layer 1, or one obtained by applying the slipping agent to the surface of the base material layer 1.

The thickness of the base material layer 1 is not particularly limited as long as a function as a base material is performed, and the thickness of the base material layer 1 is, for example, about 3 μm, preferably about 10 μm. The thickness of the base material layer 1 is, for example, about 50 μm or less, preferably 35 μm or less. The thickness of the base material layer 1 is preferably in the range of, for example, about 3 to 50 μm, about 3 to 35 μm, about 10 to 50 μm, or about 10 to 35 μm, and the thickness is preferably about 3 to 35 μm for reducing the weight and the thickness of the electrical storage device, and preferably about 35 to 50 μm for improving moldability. The thickness of the polyamide layer is, for example, about 3 μm or more, preferably about 10 μm or more, and about 18 μm or more, and for example, about 50 μm or less, preferably about 35 μm or less, about 28 μm or less, or about 18 μm or less. The thickness of the polyamide layer is preferably in the range of, for example, about 3 to 50 μm, about 3 to 35 μm, about 3 to 28 m, about 3 to 18 μm, about 10 to 50 μm, about 10 to 35 μm, about 10 to 28 m, about 10 to 18 μm, about 18 to 50 μm, about 18 to 35 μm, or about 18 to 28 m, and in particular, the thickness is preferably about 3 to 18 μm for reducing the weight and the thickness of the electrical storage device, and preferably about 18 to 50 μm for improving moldability. When the base material layer 1 is a resin film laminate with two or more layers, the thickness of the resin film forming each layer is not particularly limited, and is, for example, about 2 μm, preferably about 10 μm or more, or about 18 μm or more. The thickness of the resin film forming each layer is, for example, about 33 μm or less, preferably about 28 μm or less, about 23 μm or less, or about 18 μm or less. The thickness of the resin film forming each layer is about 2 to 33 μm, about 2 to 28 μm, about 2 to 23 μm, about 2 to 18 μm, about 10 to 33 μm, about 10 to 28 μm, about 10 to 23 μm, about 10 to 18 μm, about 18 to 33 μm, about 18 to 28 μm, or about 18 to 23 μm.

### [Adhesive Agent Layer 2]

In the exterior material for electrical storage devices according to the present disclosure, the adhesive agent layer 2 is a layer provided between the base material layer 1 and the barrier layer 3 for the purpose of enhancing bondability between these layers.

In the present disclosure, the glass transition temperature (Tg) of the adhesive agent layer 2 is 100° C. or higher and 139° C. or lower. As described above, in the present disclosure, the base material layer 1 including a polyamide layer whose heat shrinkage ratio is equal to or smaller than a predetermined value at 180° C. in the machine direction and an adhesive agent layer 2 described later whose glass transition temperature (Tg) is set within a specific range are combined to suppress delamination between the polyamide layer and the barrier layer in the case of placement in a high-temperature environment (at about 120° C.), and suppress warpage of an exterior material for electrical storage devices due to cutting. From the viewpoint of more suitably exhibiting the effect of the invention of the present disclosure, the glass transition temperature (Tg) of the adhesive agent layer 2 is preferably 105° C. or higher, more preferably 108° C. or higher, still more preferably 111° C. or higher. From the same viewpoint, the glass transition temperature of the adhesive agent layer 2 is preferably 135° C. or lower, more preferably 130° C. or lower, still more preferably 125° C. or lower. The glass transition temperature of the adhesive agent layer 2 is preferably in the range of about 100 to 135° C., about 100 to 130° C., about 100 to 125° C., about 105 to 139° C., about 105 to 135° C., about 105 to 130° C., about 105 to 125° C., about 108 to 139° C., about 108 to 135° C., about 108 to 130° C., about 108 to 125° C., about 111 to 139° C., about 111 to 135° C., about 111 to 130° C., or about 111 to 125° C. The method for measuring the glass transition temperature of the adhesive agent layer 2 is as follows.

### <Method for Measuring Glass Transition Temperature>

The glass transition temperature (Tg) of the adhesive agent layer is a value measured using a rigid body pendulum-type viscoelasticity measuring apparatus (for example, model: RPT-3000W manufactured by A&D Company, Limited). The measurement conditions are as follows: pipe: RBP-080 (8 mmφ pipe), frame: FRB-100, measurement temperature: the sample is heated from room temperature (25° C.) to 30° C. at a temperature rise rate of 6° C./min, held at 30° C. for 5 minutes, and heated to 180° C. at a temperature rise rate of 3° C./min, adsorption time: 1 second, and measurement interval: 10 seconds. The adhesive agent layer is peeled from the exterior material for electrical storage devices, and used for measurement. Specifically, the base material layer and the barrier layer are peeled from each other, and with an adhesive attached on one of the layers, the glass transition temperature of the adhesive agent layer is measured.

Preferably, the adhesive agent layer 2 is in contact with the polyamide layer. Preferably, the adhesive agent layer 2 is also in contact with the barrier layer 3. Preferably, the adhesive agent layer 2 bond the polyamide layer and the barrier layer 3 to each other by being in contact with each of these layers. When an easily adhesive layer forms a surface of the polyamide layer as described above (that is, the polyamide layer includes an easily adhesive layer as its surface structure), it is preferable that the easily adhesive layer of the polyamide layer and the adhesive agent layer 2 are in contact with each other. Similarly, when a corrosion-resistant film forms a surface of the barrier layer 3 as described later (that is, the barrier layer 3 includes a corrosion-resistant film as its surface structure), it is preferable that the corrosion-resistant film of the barrier layer 3 and the adhesive agent layer 2 are in contact with each other.

The adhesive for forming the adhesive agent layer 2 may be any of a chemical reaction type, a solvent volatilization type, a heat melting type, a heat pressing type, and the like as long as it can form an adhesive agent layer having moisture and heat resistance. The adhesive agent may be a two-liquid curable adhesive (two-liquid adhesive), a one-liquid curable adhesive (one-liquid adhesive), or a resin that does not involve curing reaction. The adhesive agent layer 2 may be a single layer or a multi-layer.

Specific examples of the adhesive component contained in the adhesive include polyester such as polyethylene terephthalate, polybutylene terephthalate, polyethylene naphthalate, polybutylene naphthalate, polyethylene isophthalate and copolyester; polyether; polyurethane; epoxy resins; phenol resins; polyamides such as nylon 6, nylon 66, nylon 12 and copolymerized polyamide; polyolefin-based resins such as polyolefins, cyclic polyolefins, acid-modified polyolefins and acid-modified cyclic polyolefins; cellulose; (meth)acrylic resins; polyimide; polycarbonate; amino resins such as urea resins and melamine resins; rubbers such as chloroprene rubber, nitrile rubber and styrene-butadiene rubber; and silicone resins. These adhesive components may be used alone, or may be used in combination of two or more thereof. Of these adhesive components, polyurethane-based adhesives are preferable. In addition, the adhesive strength of these resins used as adhesive components can be increased by using an appropriate curing agent in combination. As the curing agent, appropriate one is selected from polyisocyanate, a polyfunctional epoxy resin, an oxazoline group-containing polymer, a polyamine resin, an acid anhydride and the like according to the functional group of the adhesive component.

Examples of the polyurethane adhesive include polyurethane adhesives containing a first component containing a polyol compound and a second component containing an isocyanate compound. The polyurethane adhesive is preferably a two-liquid curable polyurethane adhesive having polyol such as polyester polyol, polyether polyol or acrylic polyol as a first component, and aromatic or aliphatic polyisocyanate as a second component. Examples of the polyurethane adhesive include polyurethane adhesives containing an isocyanate compound and a polyurethane compound obtained by reacting a polyol compound with an isocyanate compound in advance. Examples of the polyurethane adhesive include polyurethane adhesives containing a polyol compound and a polyurethane compound obtained by reacting a polyol compound with an isocyanate compound in advance. Examples of the polyurethane adhesive include polyurethane adhesives obtained by reacting a polyol compound with an isocyanate compound to form a polyurethane compound in advance, and reacting the polyurethane compound with moisture in the air or the like. Preferably, polyester polyol having a hydroxyl group in the side chain in addition to a hydroxyl group at the end of the repeating unit is used as the polyol compound. Examples of the curing agent include aliphatic, alicyclic, aromatic and araliphatic isocyanate-based compounds. Examples of the isocyanate-based compound include hexamethylene diisocyanate (HDI), xylylene diisocyanate (XDI), isophorone diisocyanate (IPDI), hydrogenated XDI (H6XDI), hydrogenated MDI (H 12 MDI), tolylene diisocyanate (TDI), diphenylmethane diisocyanate (MDI) and naphthalene diisocyanate (NDI). Examples of the isocyanate-based compound also include polyfunctional isocyanate-modified products of one or more of these diisocyanates can be mentioned. It is also possible to use a multimer (e.g. a trimer) as the polyisocyanate compound. Examples of the multimer include adducts, biurets, and nurates. Since the adhesive agent layer 2 is formed of a polyurethane adhesive, excellent electrolytic solution resistance is imparted to the exterior material for electrical storage devices, so that peeling of the base material layer 1 is suppressed even if the electrolytic solution is deposited on the side surface.

When the adhesive agent layer 2 is formed of a cured product of a two-liquid polyurethane adhesive, the glass transition temperature of the adhesive agent layer 2 satisfies the above-described glass transition temperature of the adhesive agent layer 2. That is, the glass transition temperature of the adhesive agent layer 2 formed of a cured product of a two-liquid polyurethane adhesive is 100° C. or higher and 139° C. or lower, preferably 105° C. or higher, more preferably 108° C. or higher, still more preferably 111° C. or higher. From the same viewpoint, the glass transition temperature of the adhesive agent layer 2 is preferably 135° C. or lower, more preferably 130° C. or lower, still more preferably 125° C. or lower. The glass transition temperature of the adhesive agent layer 2 is preferably in the range of about 100 to 135° C., about 100 to 130° C., about 100 to 125° C., about 105 to 139° C., about 105 to 135° C., about 105 to 130° C., about 105 to 125° C., about 108 to 139° C., about 108 to 135° C., about 108 to 130° C., about 108 to 125° C., about 111 to 139° C., about 111 to 135° C., about 111 to 130° C., or about 111 to 125° C.

In the exterior material for electrical storage devices according to the present disclosure, the adhesive for forming the adhesive agent layer 2 is preferably a two-liquid polyurethane adhesive. Preferably, a compound containing a substituent which increases the cohesive force after curing and reacts with an acid, such as a carbodiimide group or an epoxy group, is added to the two-liquid polyurethane adhesive. It is preferable to adjust, for example, the ratio of the soft segment and the hard segment contained in the polyol compound for enhancing the flexibility of the polyurethane. When the adhesive agent layer 2 is formed of a cured product of a two-liquid polyurethane adhesive, it is preferable that the polyol compound forming the adhesive agent layer 2 contains another basic acid component and a polyhydric alcohol component, and the other basic acid component contains a soft segment and a hard segment. Examples of the soft segment include isophthalic acid and derivatives thereof, and examples of the hard segment include terephthalic acid and derivatives thereof. For enhancing the flexibility of the adhesive agent layer 2, for example, the mass ratio of the soft segment (e.g. isophthalic acid and derivatives thereof) and the hard segment (e.g. terephthalic acid and derivatives thereof) (soft segment: hard segment) is preferably about 35:65 to 90:10, more preferably about 40:60 to 85:15. For enhancing the moisture and heat resistance of the polyurethane after curing, it is desirable that the amount of a catalyst residue contained in the two-liquid polyurethane adhesive be reduced to decrease the hydrolysis rate of the polyurethane. Further, it is preferable to adjust the glass transition temperature of the two-liquid polyurethane adhesive after curing.

Other components may be added to the adhesive agent layer 2 as long as bondability moldability and moisture and heat resistance are not inhibited, and the adhesive agent layer 2 may contain a colorant, a thermoplastic elastomer, a tackifier, a filler, and the like. When the adhesive agent layer 2 contains a colorant, the exterior material for electrical storage devices can be colored. As the colorant, known colorants such as pigments and dyes can be used. The colorants may be used alone, or may be used in combination of two or more thereof.

The type of pigment is not particularly limited as long as the bondability of the adhesive agent layer 2 is not impaired. Examples of the organic pigment include azo-based pigments, phthalocyanine-based pigments, quinacridone-based pigments, anthraquinone-based pigments, dioxazine-based pigments, indigothioindigo-based pigments, perinone-perylene-based pigments, isoindolenine-based pigments and benzimidazolone-based pigments. Examples of the inorganic pigment include carbon black-based pigments, titanium oxide-based pigments, cadmium-based pigments, lead-based pigments, chromium-based pigments and iron-based pigments, and also fine powder of mica (mica) and fish scale foil.

Of the colorants, carbon black is preferable for the purpose of, for example, blackening the appearance of the exterior material for electrical storage devices.

The average particle diameter of the pigment is not particularly limited, and is, for example, about 0.05 to 5 μm, preferably about 0.08 to 2 μm. The average particle size of the pigment is a median diameter measured by a laser diffraction/scattering particle size distribution measuring apparatus.

The content of the pigment in the adhesive agent layer 2 is not particularly limited as long as the exterior material for electrical storage devices is colored, and the content is, for example, about 5 to 60 mass %, preferably 10 to 40 mass %.

The thickness of the adhesive agent layer 2 is not particularly limited as long as the base material layer 1 and the barrier layer 3 can be bonded to each other, and the thickness is, for example, about 1 μm or more, or about 2 μm or more. The thickness of the adhesive agent layer 2 is, for example, about 10 μm or less, or about 5 μm or less. The thickness of the adhesive agent layer 2 is preferably in the range of about 1 to 10 μm, about 1 to 5 μm, about 2 to 10 μm, or about 2 to 5 μm.

### [Colored Layer]

The colored layer is a layer provided between the base material layer 1 and the barrier layer 3 if necessary (not shown). When the adhesive agent layer 2 is present, the colored layer may be provided between the base material layer 1 and the adhesive agent layer 2 or between the adhesive agent layer 2 and the barrier layer 3. The colored layer may be provided outside the base material layer 1. By providing the colored layer, the exterior material for electrical storage devices can be colored.

The colored layer can be formed by, for example, applying an ink containing a colorant to the surface of the base material layer 1, or the surface of the barrier layer 3. As the colorant, known colorants such as pigments and dyes can be used. The colorants may be used alone, or may be used in combination of two or more thereof.

Specific examples of the colorant contained in the colored layer include the same colorants as those exemplified in the section [Adhesive Agent Layer 2].

### [Barrier Layer 3]

In the exterior material for electrical storage devices, the barrier layer 3 is a layer which suppresses at least ingress of moisture.

Examples of the barrier layer 3 include metal foils, deposited films and resin layers having a barrier property. Examples of the deposited film include metal deposited films, inorganic oxide deposited films and carbon-containing inorganic oxide deposited films, and examples of the resin layer include those of polyvinylidene chloride, fluorine-containing resins such as polymers containing chlorotrifluoroethylene (CTFE) as a main component, polymers containing tetrafluoroethylene (TFE) as a main component, polymers having a fluoroalkyl group, and polymers containing a fluoroalkyl unit as a main component, and ethylene vinyl alcohol copolymers. Examples of the barrier layer 3 include resin films provided with at least one of these deposited films and resin layers. A plurality of barrier layers 3 may be provided. Preferably, the barrier layer 3 contains a layer formed of a metal material. Specific examples of the metal material forming the barrier layer 3 include aluminum alloys, stainless steel, titanium steel and steel sheets. When the metal material is used as a metal foil, it is preferable that the metal material includes at least one of an aluminum alloy foil and a stainless steel foil.

The aluminum alloy is more preferably a soft aluminum alloy foil formed of, for example, an annealed aluminum alloy from the viewpoint of improving the moldability of the exterior material for electrical storage devices, and is preferably an aluminum alloy foil containing iron from the viewpoint of further improving the moldability. In the aluminum alloy foil containing iron (100 mass %), the content of iron is preferably 0.1 to 9.0 mass %, more preferably 0.5 to 2.0 mass %. When the content of iron is 0.1 mass % or more, it is possible to obtain an exterior material for electrical storage devices which has more excellent moldability. When the content of iron is 9.0 mass % or less, it is possible to obtain an exterior material for electrical storage devices which is more excellent in flexibility. Examples of the soft aluminum alloy foil include aluminum alloy foils having a composition specified in JIS H4160: 1994 A8021H-O, JIS H4160: 1994 A8079H-O, JIS H4000: 2014 A8021P-O, or JIS H4000: 2014 A8079P-O. If necessary, silicon, magnesium, copper, manganese or the like may be added. Softening can be performed by annealing or the like.

Examples of the stainless steel foil include austenitic stainless steel foils, ferritic stainless steel foils, austenitic/ferritic stainless steel foils, martensitic stainless steel foils and precipitation-hardened stainless steel foils. From the viewpoint of providing an exterior material for electrical storage devices which is further excellent in moldability, it is preferable that the stainless steel foil is formed of austenitic stainless steel.

Specific examples of the austenite-based stainless steel foil include SUS 304 stainless steel, SUS 301 stainless steel and SUS 316L stainless steel, and of these, SUS 304 stainless steel is especially preferable.

When the barrier layer 3 is a metal foil, the barrier layer 3 may perform a function as a barrier layer suppressing at least ingress of moisture, and has a thickness of, for example, about 9 to 200 μm. The thickness of the barrier layer 3 is preferably about 85 μm or less, more preferably about 50 μm or less, still more preferably about 40 μm or less, particularly preferably about 35 μm or less. The thickness of the barrier layer 3 is preferably about 10 μm or more, more preferably about 20 μm or more, still more preferably about 25 μm or more. The total thickness of the barrier layer 3 is preferably in the range of about 10 to 85 μm, about 10 to 50 μm, about 10 to 40 μm, about 10 to 35 μm, about 20 to 85 μm, about 20 to 50 μm, about 20 to 40 μm, about 20 to 35 μm, about 25 to 85 μm, about 25 to 50 μm, about 25 to 40 μm, or about 25 to 35 μm. When the barrier layer 3 is formed of an aluminum alloy foil, the thickness thereof is especially preferably in above-described range. When the barrier layer 3 includes an aluminum alloy foil, the thickness of the barrier layer 3 is preferably about 45 μm or more, more preferably about 50 μm or more, still more preferably about 55 μm or more, and preferably about 85 μm or less, more preferably 75 μm or less, still more preferably 70 μm or less, from the viewpoint of imparting high moldability and high rigidity to the exterior material 10 for electrical storage devices. The thickness of the barrier layer 3 is preferably in the range of about 45 to 85 μm, about 45 to 75 μm, about 45 to 70 μm, about 50 to 85 μm, about 50 to 75 μm, about 50 to 70 μm, about 55 to 85 μm, about 55 to 75 μm, or about 55 to 70 μm. When the exterior material 10 for electrical storage devices has high moldability, deep drawing molding can be facilitated to contribute to an increase in capacity of the electrical storage device. When the capacity of the electrical storage device is increased, the weight of the electrical storage device increases, but the enhancement of the rigidity of the exterior material 10 for electrical storage devices can contribute to high hermeticity of the electrical storage device. In particular, when the barrier layer 3 includes a stainless steel foil, the thickness of the stainless steel foil is preferably about 60 μm or less, more preferably about 50 μm or less, still more preferably about 40 μm or less, even more preferably about 30 μm or less, particularly preferably about 25 μm or less. The thickness of the stainless steel foil is preferably about 10 μm or more, more preferably about 15 μm or more. The thickness of the stainless steel foil is preferably in the range of about 10 to 60 μm, about 10 to 50 μm, about 10 to 40 μm, about 10 to 30 μm, about 10 to 25 μm, about 15 to 60 μm, about 15 to 50 μm, about 15 to 40 μm, about 15 to 30 μm, or about 15 to 25 μm.

When the barrier layer 3 is a metal foil, it is preferable that a corrosion-resistant film is provided at least on a surface on a side opposite to the base material layer for preventing dissolution and corrosion. The barrier layer 3 may include a corrosion-resistant film on each of both surfaces. Here, the corrosion-resistant film refers to a thin film obtained by subjecting the surface of the barrier layer to, for example, hydrothermal denaturation treatment such as boehmite treatment, chemical conversion treatment, anodization treatment, plating treatment with nickel, chromium or the like, or corrosion prevention treatment by applying a coating agent to impart corrosion resistance (e.g. acid resistance and alkali resistance) to the barrier layer. Specifically, the corrosion-resistant film means a film which improves the acid resistance of the barrier layer (acid-resistant film), a film which improves the alkali resistance of the barrier layer (alkali-resistant film), or the like. One of treatments for forming the corrosion-resistant film may be performed, or two or more thereof may be performed in combination. In addition, not only one layer but also multiple layers can be formed. Further, of these treatments, the hydrothermal denaturation treatment and the anodization treatment are treatments in which the surface of the metal foil is dissolved with a treatment agent to form a metal compound excellent in corrosion resistance. The definition of the chemical conversion treatment may include these treatments. When the barrier layer 3 is provided with the corrosion-resistant film, the barrier layer 3 is regarded as including the corrosion-resistant film.

The corrosion-resistant film exhibits the effects of preventing delamination between the barrier layer (e.g. an aluminum alloy foil) and the base material layer during molding of the exterior material for electrical storage devices; preventing dissolution and corrosion of the surface of the barrier layer, particularly dissolution and corrosion of aluminum oxide present on the surface of the barrier layer when the barrier layer is an aluminum alloy foil, by hydrogen fluoride generated by reaction of an electrolyte with moisture; improving the bondability (wettability) of the surface of the barrier layer; preventing delamination between the base material layer and the barrier layer during heat-sealing; and preventing delamination between the base material layer and the barrier layer during molding.

Various corrosion-resistant films formed by chemical conversion treatment are known, and examples thereof include mainly corrosion-resistant films containing at least one of a phosphate, a chromate, a fluoride, a triazine thiol compound, and a rare earth oxide. Examples of the chemical conversion treatment using a phosphate or a chromate include chromic acid chromate treatment, phosphoric acid chromate treatment, phosphoric acid-chromate treatment and chromate treatment, and examples of the chromium compound used in these treatments include chromium nitrate, chromium fluoride, chromium sulfate, chromium acetate, chromium oxalate, chromium biphosphate, acetylacetate chromate, chromium chloride and chromium potassium sulfate. Examples of the phosphorus compound used in these treatments include sodium phosphate, potassium phosphate, ammonium phosphate and polyphosphoric acid. Examples of the chromate treatment include etching chromate treatment, electrolytic chromate treatment and coating-type chromate treatment, and coating-type chromate treatment is preferable. This coating-type chromate treatment is treatment in which at least a surface of the barrier layer (e.g. an aluminum alloy foil) on the inner layer side is first degreased by a well-known treatment method such as an alkali immersion method, an electrolytic cleaning method, an acid cleaning method, an electrolytic acid cleaning method or an acid activation method, and a treatment solution containing a metal phosphate such as Cr (chromium) phosphate, Ti (titanium) phosphate, Zr (zirconium) phosphate or Zn (zinc) phosphate or a mixture of these metal salts as a main component, a treatment solution containing any of non-metal salts of phosphoric acid and a mixture of these non-metal salts as a main component, or a treatment solution formed of a mixture of any of these salts and a synthetic resin or the like is then applied to the degreased surface by a well-known coating method such as a roll coating method, a gravure printing method or an immersion method, and dried. As the treatment liquid, for example, various solvents such as water, an alcohol-based solvent, a hydrocarbon-based solvent, a ketone-based solvent, an ester-based solvent, and an ether-based solvent can be used, and water is preferable. Examples of the resin component used here include polymers such as phenol-based resins and acryl-based resins, and examples of the treatment include chromate treatment using an aminated phenol polymer having any of repeating units represented by the following general formulae (1) to (4). In the aminated phenol polymer, the repeating units represented by the following general formulae (1) to (4) may be contained alone, or may be contained in combination of two or more thereof. The acryl-based resin is preferably polyacrylic acid, an acrylic acid-methacrylic acid ester copolymer, an acrylic acid-maleic acid copolymer, an acrylic acid-styrene copolymer, or a derivative thereof such as a sodium salt, an ammonium salt or an amine salt thereof. In particular, a derivative of polyacrylic acid such as an ammonium salt, a sodium salt or an amine salt of polyacrylic acid is preferable. In the present disclosure, the polyacrylic acid means a polymer of acrylic acid. The acryl-based resin is also preferably a copolymer of acrylic acid and dicarboxylic acid or dicarboxylic anhydride, and is also preferably an ammonium salt, a sodium salt or an amine salt of a copolymer of acrylic acid and dicarboxylic acid or dicarboxylic anhydride. The acryl-based resins may be used alone, or may be used in combination of two or more thereof.

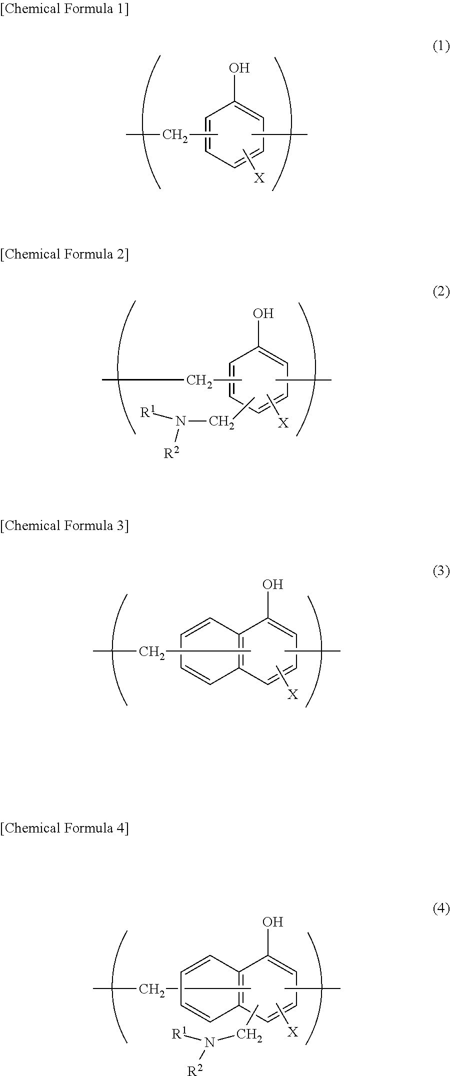

In the general formulae (1) to (4), X represents a hydrogen atom, a hydroxy group, an alkyl group, a hydroxyalkyl group, an allyl group, or a benzyl group. R¹ and R² are the same or different, and each represents a hydroxy group, an alkyl group, or a hydroxyalkyl group. In the general formulae (1) to (4), examples of the alkyl group represented by X, R¹ and R² include linear or branched alkyl groups with a carbon number of 1 to 4, such as a methyl group, an ethyl group, an n-propyl group, an isopropyl group, an n-butyl group, an isobutyl group, and a tert-butyl group. Examples of the hydroxyalkyl group represented by X, R¹ and R² include linear or branched alkyl groups with a carbon number of 1 to 4, which is substituted with one hydroxy group, such as a hydroxymethyl group, a 1-hydroxyethyl group, a 2-hydroxyethyl group, a 1-hydroxypropyl group, a 2-hydroxypropyl group, a 3-hydroxypropyl group, a 1-hydroxybutyl group, a 2-hydroxybutyl group, a 3-hydroxybutyl group, and a 4-hydroxybutyl group. In the general formulae (1) to (4), the alkyl group and the hydroxyalkyl group represented by X, R¹ and R² may be the same or different. In the general formulae (1) to (4), X is preferably a hydrogen atom, a hydroxy group or a hydroxyalkyl group. A number average molecular weight of the aminated phenol polymer having repeating units represented by the general formulae (1) to (4) is preferably about 500 to 1,000,000, and more preferably about 1,000 to 20,000, for example. The aminated phenol polymer is produced by, for example, performing polycondensation of a phenol compound or a naphthol compound with formaldehyde to prepare a polymer including repeating units represented by the general formula (1) or the general formula (3), and then introducing a functional group (—CH₂NR¹R²) into the obtained polymer using formaldehyde and an amine (R¹R²NH). The aminated phenol polymers are used alone, or used in combination of two or more thereof.

Other examples of the corrosion-resistant film include thin films formed by corrosion prevention treatment of coating type in which a coating agent containing at least one selected from the group consisting of a rare earth element oxide sol, an anionic polymer and a cationic polymer is applied. The coating agent may further contain phosphoric acid or a phosphate, and a crosslinker for crosslinking the polymer. In the rare earth element oxide sol, fine particles of a rare earth element oxide (e.g. particles having an average particle diameter of 100 nm or less) are dispersed in a liquid dispersion medium. Examples of the rare earth element oxide include cerium oxide, yttrium oxide, neodymium oxide and lanthanum oxide, and cerium oxide is preferable from the viewpoint of further improving adhesion. The rare earth element oxides contained in the corrosion-resistant film can be used alone, or used in combination of two or more thereof. As the liquid dispersion medium for the rare earth element oxide, for example, various solvents such as water, an alcohol-based solvent, a hydrocarbon-based solvent, a ketone-based solvent, an ester-based solvent, and an ether-based solvent can be used, and water is preferable. For example, the cationic polymer is preferably polyethyleneimine, an ion polymer complex formed of a polymer having polyethyleneimine and a carboxylic acid, primary amine-grafted acrylic resins obtained by graft-polymerizing a primary amine with an acrylic main backbone, polyallylamine or a derivative thereof, or aminated phenol. The anionic polymer is preferably poly(meth)acrylic acid or a salt thereof, or a copolymer containing (meth)acrylic acid or a salt thereof as a main component. The crosslinker is preferably at least one selected from the group consisting of a silane coupling agent and a compound having any of functional groups including an isocyanate group, a glycidyl group, a carboxyl group and an oxazoline group. In addition, the phosphoric acid or phosphate is preferably condensed phosphoric acid or a condensed phosphate.

Examples of the corrosion-resistant film include films formed by applying a dispersion of fine particles of a metal oxide such as aluminum oxide, titanium oxide, cerium oxide or tin oxide or barium sulfate in phosphoric acid to the surface of the barrier layer and performing baking treatment at 150° C. or higher.

The corrosion-resistant film may have a laminated structure in which at least one of a cationic polymer and an anionic polymer is further laminated if necessary. Examples of the cationic polymer and the anionic polymer include those described above.

The composition of the corrosion-resistant film can be analyzed by, for example, time-of-flight secondary ion mass spectrometry.

The amount of the corrosion-resistant film to be formed on the surface of the barrier layer 3 in the chemical conversion treatment is not particularly limited, but for example when the coating-type chromate treatment is performed, and it is desirable that the chromic acid compound be contained in an amount of, for example, about 0.5 to 50 mg, preferably about 1.0 to 40 mg, in terms of chromium, the phosphorus compound be contained in an amount of, for example, about 0.5 to 50 mg, preferably about 1.0 to 40 mg, in terms of phosphorus, and the aminated phenol polymer be contained in an amount of, for example, about 1.0 to 200 mg, preferably about 5.0 to 150 mg, per 1 m² of the surface of the barrier layer 3.

The thickness of the corrosion-resistant film is not particularly limited, and is preferably about 1 nm to 20 μm, more preferably about 1 nm to 100 nm, still more preferably about 1 nm to 50 nm from the viewpoint of the cohesive force of the film and the adhesive strength with the barrier layer and the heat-sealable resin layer. The thickness of the corrosion-resistant film can be measured by observation with a transmission electron microscope or a combination of observation with a transmission electron microscope and energy dispersive X-ray spectroscopy or electron beam energy loss spectroscopy. By analyzing the composition of the corrosion-resistant film using time-of-flight secondary ion mass spectrometry, peaks derived from secondary ions from, for example, Ce, P and O (e.g. at least one of Ce₂PO₄⁺, CePO₄⁻ and the like) and secondary ions from, for example, Cr, P and O (e.g. at least one of CrPO₂⁺, CrPO₄⁻ and the like) are detected.

The chemical conversion treatment is performed in the following manner: a solution containing a compound to be used for formation of a corrosion-resistant film is applied to the surface of the barrier layer by a bar coating method, a roll coating method, a gravure coating method, an immersion method or the like, and heating is then performed so that the temperature of the barrier layer is about 70 to about 200° C. The barrier layer may be subjected to a degreasing treatment by an alkali immersion method, an electrolytic cleaning method, an acid cleaning method, an electrolytic acid cleaning method or the like before the barrier layer is subjected to a chemical conversion treatment. When a degreasing treatment is performed as described above, the chemical conversion treatment of the surface of the barrier layer can be further efficiently performed. When an acid degreasing agent with a fluorine-containing compound dissolved in an inorganic acid is used for degreasing treatment, not only a metal foil degreasing effect can be obtained but also a metal fluoride can be formed as a passive state, and in this case, only degreasing treatment may be performed.

### [Heat-Sealable Resin Layer 4]

In the exterior material for electrical storage devices according to the present disclosure, the heat-sealable resin layer 4 is a layer (sealant layer) which corresponds to an innermost layer and performs a function of hermetically sealing the electrical storage device element by heat-sealing the heat-sealable resin layer during construction of the electrical storage device.

The resin forming the heat-sealable resin layer 4 is not particularly limited as long as it can be heat-sealed, a resin containing a polyolefin backbone such as a polyolefin or an acid-modified polyolefin is preferable. The resin forming the heat-sealable resin layer 4 can be confirmed to contain a polyolefin backbone by an analysis method such as infrared spectroscopy or gas chromatography-mass spectrometry. It is preferable that a peak derived from maleic anhydride is detected when the resin forming the heat-sealable resin layer 4 is analyzed by infrared spectroscopy. For example, when a maleic anhydride-modified polyolefin is measured by infrared spectroscopy, peaks derived from maleic anhydride are detected near wavenumbers of 1760 cm⁻¹ and 1780 cm⁻¹. When the heat-sealable resin layer 4 is a layer formed of a maleic anhydride-modified polyolefin, a peak derived from maleic anhydride is detected when measurement is performed by infrared spectroscopy. However, if the degree of acid modification is low, the peaks may be too small to be detected. In that case, the peaks can be analyzed by nuclear magnetic resonance spectroscopy.

The heat-sealable resin layer 4 preferably contains a resin containing a polyolefin backbone as a main component, more preferably contains polyolefin as a main component, still more preferably contains polypropylene as a main component. Here, the main component means a resin component, the content ratio of which is, for example, 50 mass % or more, preferably 60 mass % or more, more preferably 70 mass % or more, still more preferably 80 mass % or more, still more preferably 90 mass % or more, still more preferably 95 mass % or more, still more preferably 98 mass % or more, still more preferably 99 mass % or more with respect to resin components contained in the heat-sealable resin layer 4. For example, the phrase “the heat-sealable resin layer 4 contains polypropylene as a main component” means that the content ratio of polypropylene is, for example, 50 mass % or more, preferably 60 mass % or more, more preferably 70 mass % or more, still more preferably 80 mass % or more, still more preferably 90 mass % or more, still more preferably 95 mass % or more, still more preferably 98 mass % or more, still more preferably 99 mass % or more with respect to resin components contained in the heat-sealable resin layer 4.

Specific examples of the polyolefin include polyethylenes such as low-density polyethylene, medium-density polyethylene, high-density polyethylene and linear low-density polyethylene; ethylene-α-olefin copolymers; polypropylene such as homopolypropylene, block copolymers of polypropylene (e.g., block copolymers of propylene and ethylene) and random copolymers of polypropylene (e.g., random copolymers of propylene and ethylene); propylene-α-olefin copolymers; and terpolymers of ethylene-butene-propylene. Of these, polypropylene is preferable. The polyolefin resin in the case of a copolymer may be a block copolymer or a random copolymer. These polyolefin-based resins may be used alone, or may be used in combination of two or more thereof.

The polyolefin may be a cyclic polyolefin. The cyclic polyolefin is a copolymer of an olefin and a cyclic monomer, and examples of the olefin as a constituent monomer of the cyclic polyolefin include ethylene, propylene, 4-methyl-1-pentene, styrene, butadiene and isoprene. Examples of the cyclic monomer as a constituent monomer of the cyclic polyolefin include cyclic alkenes such as norbornene; cyclic dienes such as cyclopentadiene, dicyclopentadiene, cyclohexadiene and norbornadiene. Among these polyolefins, cyclic alkenes are preferable, and norbornene is more preferable.

The polyolefin may be an acid-modified polyolefin. The acid-modified polyolefin is a polymer with the polyolefin modified by subjecting the polyolefin to block polymerization or graft polymerization with an acid component. As the polyolefin to be acid-modified, the above-mentioned polyolefins, copolymers obtained by copolymerizing polar molecules such as acrylic acid or methacrylic acid with the above-mentioned polyolefins, polymers such as crosslinked polyolefins, or the like can also be used. Examples of the acid component to be used for acid modification include carboxylic acids such as maleic acid, acrylic acid, itaconic acid, crotonic acid, maleic anhydride and itaconic anhydride, and anhydrides thereof.

The acid-modified polyolefin may be an acid-modified cyclic polyolefin. The acid-modified polyolefin may be an acid-modified cyclic polyolefin. The acid-modified cyclic polyolefin is a polymer obtained by copolymerizing a part of monomers forming the cyclic polyolefin in place of an acid component, or block-polymerizing or graft-polymerizing an acid component with the cyclic polyolefin. The cyclic polyolefin to be modified with an acid is the same as described above. The acid component to be used for acid modification is the same as the acid component used for modification of the polyolefin.

Examples of preferred acid-modified polyolefins include polyolefins modified with a carboxylic acid or an anhydride thereof, polypropylene modified with a carboxylic acid or an anhydride thereof, maleic anhydride-modified polyolefins, and maleic anhydride-modified polypropylene.

The heat-sealable resin layer 4 may be formed from one resin alone, or may be formed from a blend polymer obtained by combining two or more resins. Further, the heat-sealable resin layer 4 may be composed of only one layer, or may be composed of two or more layers with the same resin component or different resin components.

In manufacturing of the exterior material 10 for electrical storage devices according to the present disclosure by laminating the heat-sealable resin layer 4 with the barrier layer 3, the adhesive layer 5 or the like, a resin film formed in advance may be used as the heat-sealable resin layer 4. A heat-sealable resin for forming the heat-sealable resin layer 4 may be formed into a film on the surface of the barrier layer 3, the adhesive layer 5 or the like by extrusion molding, coating or the like to obtain the heat-sealable resin layer 4 formed of a resin film.

The heat-sealable resin layer 4 may contain a slipping agent etc. if necessary. When the heat-sealable resin layer 4 contains a slipping agent, the moldability of the exterior material for electrical storage devices can be improved. The slipping agent is not particularly limited, and a known slipping agent can be used.

The slipping agent is not particularly limited, and is preferably an amide-based slipping agent. Specific examples of the slipping agent include those exemplified for the base material layer 1. The slipping agents may be used alone, or may be used in combination of two or more thereof, and it is preferable to combine two or more of the slipping agents.

In the present disclosure, it is preferable that a slipping agent is present on the surface of the heat-sealable resin layer 4 and/or inside the heat-sealable resin layer 4 from the viewpoint of enhancing the moldability of the exterior material for electrical storage devices. The slipping agent is not particularly limited, and is preferably an amide-based slipping agent. Specific examples of the amide-based slipping agent include saturated fatty acid amides, unsaturated fatty acid amides, substituted amides, methylol amides, saturated fatty acid bisamides, unsaturated fatty acid bisamides, fatty acid ester amides, and aromatic bisamides. Specific examples of the saturated fatty acid amide include lauric acid amide, palmitic acid amide, stearic acid amide, behenic acid amide, and hydroxystearic acid amide. Specific examples of unsaturated fatty acid amide include oleic acid amide and erucic acid amide. Specific examples of the substituted amide include N-oleylpalmitic acid amide, N-stearyl stearic acid amide, N-stearyl oleic acid amide, N-oleyl stearic acid amide, and N-stearyl erucic acid amide. Specific examples of the methylolamide include methylolstearic acid amide. Specific examples of the saturated fatty acid bisamide include methylenebisstearic acid amide, ethylenebiscapric acid amide, ethylenebislauric acid amide, ethylenebisstearic acid amide, ethylenebishydroxystearic acid amide, ethylenebisbehenic acid amide, hexamethylenebisstearic acid amide, hexamethylenehydroxystearic acid amide, N,N′-distearyl adipic acid amide, and N,N′-distearyl sebacic acid amide. Specific examples of the unsaturated fatty acid bisamide include ethylenebisoleic acid amide, ethylenebiserucic acid amide, hexamethylenebisoleic acid amide, N,N′-dioleyladipic acid amide, and N,N′-dioleylsebacic acid amide. Specific examples of the fatty acid ester amide include stearoamideethyl stearate. Specific examples of the aromatic bisamide include m-xylylenebisstearic acid amide, m-xylylenebishydroxystearic acid amide, and N,N′-distearylisophthalic acid amide. The slipping agents may be used alone, or may be used in combination of two or more thereof, and it is preferable to combine two or more of the slipping agents.

When a slipping agent is present on the surface of the heat-sealable resin layer 4, the amount of the slipping agent is not particularly limited, and from the viewpoint of improving the moldability of the exterior material for electrical storage devices, the amount of the slipping agent is preferably about 1 mg/m² or more, more preferably about 3 mg/m² or more, still more preferably about 5 mg/m² or more, still more preferably about 10 mg/m² or more, still more preferably about 15 mg/m² or more, and preferably about 50 mg/m² or less, still more preferably about 40 mg/m² or less, and is preferably in the range of about 1 to 50 mg/m², about 1 to 40 mg/m², about 3 to 50 mg/m², about 3 to 40 mg/m², about 5 to 50 mg/m², about 5 to 40 mg/m², about 10 to 50 mg/m², about 10 to 40 mg/m², about 15 to 50 mg/m², or about 15 to 40 mg/m².

When a slipping agent is present inside the heat-sealable resin layer 4, the amount of the slipping agent is not particularly limited, and from the viewpoint of improving the moldability of the exterior material for electrical storage devices, the amount of the slipping agent is preferably about 100 ppm or more, more preferably about 300 ppm or more, still more preferably about 500 ppm or more, and preferably about 3,000 ppm or less, more preferably about 2,000 ppm or less, and is preferably in the range of about 100 to 3,000 ppm, about 100 to 2,000 ppm, about 300 to 3,000 ppm, about 300 to 2,000 ppm, about 500 to 3,000 ppm, or about 500 to 2,000 ppm. When two or more slipping agents are present inside the heat-sealable resin layer 4, the above-described amount is the total amount of the slipping agents. When two or more slipping agents are present inside the heat-sealable resin layer 4, the amount of the first slipping agent is not particularly limited, and from the viewpoint of improving the moldability of the exterior material for electrical storage devices, the amount of the first slipping agent is preferably about 100 ppm or more, more preferably about 300 ppm or more, still more preferably about 500 ppm or more, and preferably about 3,000 ppm or less, more preferably about 2,000 ppm or less, and is preferably in the range of about 100 to 3,000 ppm, about 100 to 2,000 ppm, about 300 to 3,000 ppm, about 300 to 2,000 ppm, about 500 to 3,000 ppm, or about 500 to 2,000 ppm. The amount of the second slipping agent is not particularly limited, and from the viewpoint of improving the moldability of the exterior material for electrical storage devices, the amount of the slipping agent is preferably about 50 ppm or more, more preferably about 100 ppm or more, still more preferably about 200 ppm or more, and preferably about 1,500 ppm or less, more preferably about 1,000 ppm or less, and is preferably in the range of about 50 to 1,500 ppm, about 50 to 1,000 ppm, about 100 to 1,500 ppm, about 100 to 1,000 ppm, about 200 to 1,500 ppm, or about 200 to 1,000 ppm.

The slipping agent present on the surface of the heat-sealable resin layer 4 may be one obtained by exuding the slipping agent contained in the resin forming the heat-sealable resin layer 4, or one obtained by applying a slipping agent to the surface of the heat-sealable resin layer 4.

The thickness of the heat-sealable resin layer 4 is not particularly limited as long as the heat-sealable resin layers are heat-sealed to each other to perform a function of sealing the electrical storage device element, and the thickness is, for example, about 100 μm or less, preferably about 85 μm or less, more preferably about 15 to 85 μm. For example, when the thickness of the adhesive layer 5 described later is 10 μm or more, the thickness of the heat-sealable resin layer 4 is preferably about 85 μm or less, more preferably about 15 to 45 μm. For example, when the thickness of the adhesive layer 5 described later is less than 10 μm or the adhesive layer 5 is not provided, the thickness of the heat-sealable resin layer 4 is preferably about 20 μm or more, more preferably about 35 to 85 μm.

### [Adhesive Layer 5]

In the exterior material for electrical storage devices according to the present disclosure, the adhesive layer 5 is a layer provided between the barrier layer 3 (or corrosion-resistant film) and the heat-sealable resin layer 4 if necessary for firmly bonding these layers to each other.

The adhesive layer 5 is formed from a resin capable of bonding the barrier layer 3 and the heat-sealable resin layer 4 to each other. The resin to be used for forming the adhesive layer 5 is, for example, the same as that of the adhesive exemplified for the adhesive agent layer 2. From the viewpoint of firmly bonding the adhesive layer 5 to the heat-sealable resin layer 4, it is preferable that the resin to be used for forming the adhesive layer 5 contains a polyolefin backbone. Examples thereof include the polyolefins and acid-modified polyolefins exemplified for the heat-sealable resin layer 4 described above. On the other hand, from the viewpoint of firmly bonding the barrier layer 3 and the adhesive layer 5 to each other, it is preferable that the adhesive layer 5 contains an acid-modified polyolefin. Examples of the acid modifying component include dicarboxylic acids such as maleic acid, itaconic acid, succinic acid and adipic acid, anhydrides thereof, acrylic acid, and methacrylic acid, and maleic anhydride is most preferable from the viewpoint of ease of modification, general-purpose property, and the like. From the viewpoint of the heat resistance of the exterior material for electrical storage devices, the olefin component is preferably a polypropylene-based resin, and it is most preferable that the adhesive layer 5 contains maleic anhydride-modified polypropylene.

When a resin containing a polyolefin backbone is used for formation of the adhesive layer 5, the adhesive layer 5 preferably contains a resin containing a polyolefin backbone as a main component, more preferably contains acid-modified polyolefin as a main component, still more preferably contains acid-modified polypropylene as a main component. Here, the main component means a resin component, the content ratio of which is, for example, 50 mass % or more, preferably 60 mass % or more, more preferably 70 mass % or more, still more preferably 80 mass % or more, still more preferably 90 mass % or more, still more preferably 95 mass % or more, still more preferably 98 mass % or more, still more preferably 99 mass % or more with respect to resin components contained in the adhesive layer 5. For example, the phrase “the adhesive layer 5 contains acid-modified polypropylene as a main component” means that the content ratio of acid-modified polypropylene is, for example, 50 mass % or more, preferably 60 mass % or more, more preferably 70 mass % or more, still more preferably 80 mass % or more, still more preferably 90 mass % or more, still more preferably 95 mass % or more, still more preferably 98 mass % or more, still more preferably 99 mass % or more with respect to resin components contained in the adhesive layer 5.

The resin forming the adhesive layer 5 can be confirmed to contain a polyolefin backbone by an analysis method such as infrared spectroscopy, gas chromatography-mass spectrometry, and the analysis method is not particularly limited. The resin forming the adhesive layer 5 is confirmed to contain an acid-modified polyolefin, for example, when peaks derived from maleic anhydride are detected near wavenumbers of 1760 cm-1 and 1780 cm-1 when a maleic anhydride-modified polyolefin is measured by infrared spectroscopy. However, if the degree of acid modification is low, the peaks may be too small to be detected. In that case, the peaks can be analyzed by nuclear magnetic resonance spectroscopy.

Further, from the viewpoint of securing durability, such as heat resistance and content resistance and securing moldability, of the exterior material for electrical storage devices while reducing the thickness, the adhesive layer 5 is more preferably a cured product of a resin composition containing an acid-modified polyolefin and a curing agent. Preferred examples of the acid-modified polyolefin include those described above.

The adhesive layer 5 is preferably a cured product of a resin composition containing an acid-modified polyolefin and at least one selected from the group consisting of a compound having an isocyanate group, a compound having an oxazoline group, and a compound having an epoxy group, especially preferably a cured product of a resin composition containing an acid-modified polyolefin and at least one selected from the group consisting of a compound having an isocyanate group and a compound having an epoxy group. Preferably, the adhesive layer 5 preferably contains at least one selected from the group consisting of polyurethane, polyester and epoxy resin. More preferably, the adhesive layer 5 contains polyurethane and epoxy resin. As the polyester, for example, an ester resin produced by reaction of an epoxy group with a maleic anhydride group, or an amide ester resin produced by reaction of an oxazoline group with a maleic anhydride group is preferable. When an unreacted substance of a curing agent, such as a compound having an isocyanate group, a compound having an oxazoline group, or an epoxy resin remains in the adhesive layer 5, the presence of the unreacted substance can be confirmed by, for example, a method selected from infrared spectroscopy, Raman spectroscopy, time-of-flight secondary ion mass spectrometry (TOF-SIMS) and the like.

From the viewpoint of further improving adhesion between the barrier layer 3 and the adhesive layer 5, the adhesive layer 5 is preferably a cured product of a resin composition containing a curing agent having at least one selected from the group consisting of an oxygen atom, a heterocyclic ring, a C═N bond, and a C—O—C bond. Examples of the curing agent having a heterocyclic ring include curing agents having an oxazoline group, and curing agents having an epoxy group. Examples of the curing agent having a C═N bond include curing agents having an oxazoline group and curing agents having an isocyanate group. Examples of the curing agent having a C—O—C bond include curing agents having an oxazoline group, curing agents having an epoxy group. Whether the adhesive layer 5 is a cured product of a resin composition containing any of these curing agents can be confirmed by, for example, a method such as gas chromatography-mass spectrometry (GCMS), infrared spectroscopy (IR), time-of-flight secondary ion mass spectrometry (TOF-SIMS), or X-ray photoelectron spectroscopy (XPS).

The compound having an isocyanate group is not particularly limited, and is preferably a polyfunctional isocyanate compound from the viewpoint of effectively improving adhesion between the barrier layer 3 and the adhesive layer 5. The polyfunctional isocyanate compound is not particularly limited as long as it is a compound having two or more isocyanate groups. Specific examples of the polyfunctional isocyanate-based curing agent include pentane diisocyanate (PDI), isophorone diisocyanate (IPDI), hexamethylene diisocyanate (HDI), tolylene diisocyanate (TDI), diphenylmethane diisocyanate (MDI), polymerized or nurated products thereof, mixtures thereof, and copolymers of these compounds with other polymers. Examples thereof include adduct forms, biuret forms, and isocyanurate forms.

The content of the compound having an isocyanate group in the adhesive layer 5 is preferably in the range of 0.1 to 50 mass %, more preferably in the range of 0.5 to 40 mass % in the resin composition forming the adhesive layer 5. This enables effective improvement of adhesion between the barrier layer 3 and the adhesive layer 5.

The compound having an oxazoline group is not particularly limited as long as it is a compound having an oxazoline backbone. Specific examples of the compound having an oxazoline group include compounds having a polystyrene main chain and compounds having an acrylic main chain. Examples of the commercially available product include EPOCROS series manufactured by Nippon Shokubai Co., Ltd.

The proportion of the compound having an oxazoline group in the adhesive layer 5 is preferably in the range of 0.1 to 50 mass %, more preferably in the range of 0.5 to 40 mass % in the resin composition forming the adhesive layer 5. This enables effective improvement of adhesion between the barrier layer 3 and the adhesive layer 5.

Examples of the compound having an epoxy group include epoxy resins. The epoxy resin is not particularly limited as long as it is a resin capable of forming a crosslinked structure by epoxy groups existing in the molecule, and a known epoxy resin can be used. The weight average molecular weight of the epoxy resin is preferably about 50 to 2,000, more preferably about 100 to 1,000, still more preferably about 200 to 800. In the first present disclosure, the weight average molecular weight of the epoxy resin is a value obtained by performing measurement by gel permeation chromatography (GPC) under the condition of using polystyrene as a standard sample.

Specific examples of the epoxy resin include glycidyl ether derivatives of trimethylolpropane, bisphenol A diglycidyl ether, modified bisphenol A diglycidyl ether, bisphenol F-type glycidyl ether, novolak glycidyl ether, glycerin polyglycidyl ether and polyglycerin polyglycidyl ether. The epoxy resins may be used alone, or may be used in combination of two or more thereof.

The proportion of the epoxy resin in the adhesive layer 5 is preferably in the range of 0.1 to 50 mass %, more preferably in the range of 0.5 to 40 mass % in the resin composition forming the adhesive layer 5. This enables effective improvement of adhesion between the barrier layer 3 and the adhesive layer 5.

The polyurethane is not particularly limited, and a known polyurethane can be used. The adhesive layer 5 may be, for example, a cured product of two-liquid curable polyurethane.

The proportion of the polyurethane in the adhesive layer 5 is preferably in the range of 0.1 to 50 mass %, more preferably in the range of 0.5 to 40 mass % in the resin composition forming the adhesive layer 5. This enables effective improvement of adhesion between the barrier layer 3 and the adhesive layer 5 in an atmosphere including a component which induces corrosion of the barrier layer, such as an electrolytic solution.

When the adhesive layer 5 is a cured product of a resin composition containing at least one selected from the group consisting of a compound having an isocyanate group, a compound having an oxazoline group and an epoxy resin, and the acid-modified polyolefin, the acid-modified polyolefin functions as a main component, and the compound having an isocyanate group, the compound having an oxazoline group, and the compound having an epoxy group each function as a curing agent.

The adhesive layer 5 may contain a modifier having a carbodiimide group.

In manufacturing of the exterior material 10 for electrical storage devices according to the present disclosure by laminating the adhesive layer 5 with the barrier layer 3, the heat-sealable resin layer 4 or the like, a resin film formed in advance may be used as the adhesive layer 5. A heat-sealable resin for forming the adhesive layer 5 may be formed into a film on the surface of the barrier layer 3, the heat-sealable resin layer 4 or the like by extrusion molding, coating or the like to obtain the adhesive layer 5 formed of a resin film.

The thickness of the adhesive layer 5 is preferably about 50 μm or less, about 40 μm or less, about 30 μm or less, about 20 μm or less, or about 5 μm or less. The thickness of the adhesive layer 5 is preferably about 0.1 μm or more, or about 0.5 μm or more. The thickness of the adhesive layer 5 is preferably in the range of about 0.1 to 50 μm, about 0.1 to 40 μm, about 0.1 to 30 μm, about 0.1 to 20 μm, about 0.1 to 5 μm, about 0.5 to 50 μm, about 0.5 to 40 μm, about 0.5 to 30 μm, about 0.5 to 20 μm, or about 0.5 to 5 μm. More specifically, the thickness is preferably about 1 to 10 μm, more preferably about 1 to 5 μm in the case of the adhesive exemplified for the adhesive agent layer 2 or a cured product of an acid-modified polyolefin with a curing agent. When any of the resins exemplified for the heat-sealable resin layer 4 is used, the thickness of the adhesive layer is preferably about 2 to 50 μm, more preferably about 10 to 40 μm. When the adhesive layer 5 is a cured product of a resin composition containing the adhesive exemplified for the adhesive agent layer 2 or an acid-modified polyolefin and a curing agent, the adhesive layer 5 can be formed by, for example, applying the resin composition and curing the resin composition by heating or the like. When the resin exemplified for the heat-sealable resin layer 4 is used, for example, extrusion molding of the heat-sealable resin layer 4 and the adhesive layer 5 can be performed.

### [Surface Coating Layer 6]

The exterior material for electrical storage devices according to the present disclosure may include a surface coating layer 6 on the base material layer 1 (on a side opposite to the barrier layer 3 from the base material layer 1) if necessary for the purpose of improving at least one of designability, electrolytic solution resistance, scratch resistance, moldability and the like. The surface coating layer 6 is a layer located on the outermost layer side of the exterior material for electrical storage devices when the electrical storage device is constructed using the exterior material for electrical storage devices.

The surface coating layer 6 can be formed from, for example, a resin such as polyvinylidene chloride, polyester, polyurethane, acrylic resin or epoxy resin.

When the resin forming the surface coating layer 6 is a curable resin, the resin may be any of a one-liquid curable type and a two-liquid curable type, and is preferably a two-liquid curable type. Examples of the two-liquid curable resin include two-liquid curable polyurethane, two-liquid curable polyester and two-liquid curable epoxy resins. Of these, two-liquid curable polyurethane is preferable.

Examples of the two-liquid curable polyurethane include polyurethane which contains a first component containing a polyol compound and a second component containing an isocyanate compound. The polyurethane is preferably a two-liquid curable polyurethane adhesive having polyol such as polyester polyol, polyether polyol or acrylic polyol as a first component, and aromatic or aliphatic polyisocyanate as a second component. Examples of the polyurethane include polyurethane containing an isocyanate compound and a polyurethane compound obtained by reacting a polyol compound with an isocyanate compound in advance. Examples of the polyurethane include polyurethane containing a polyurethane compound and a polyurethane compound obtained by reacting a polyol compound with an isocyanate compound in advance. Examples of the polyurethane include polyurethane obtained by reacting a polyol compound with an isocyanate compound to form a polyurethane compound in advance, and reacting the polyurethane compound with moisture in the air or the like. Preferably, polyester polyol having a hydroxyl group in the side chain in addition to a hydroxyl group at the end of the repeating unit is used as the polyol compound. Examples of the second component include aliphatic, alicyclic, aromatic and araliphatic isocyanate-based compounds. Examples of the isocyanate-based compound include hexamethylene diisocyanate (HDI), xylylene diisocyanate (XDI), isophorone diisocyanate (IPDI), hydrogenated XDI (H6XDI), hydrogenated MDI (H 12 MDI), tolylene diisocyanate (TDI), diphenylmethane diisocyanate (MDI) and naphthalene diisocyanate (NDI). Examples of the isocyanate-based compound also include polyfunctional isocyanate-modified products of one or more of these diisocyanates can be mentioned. It is also possible to use a multimer (e.g. a trimer) as the polyisocyanate compound. Examples of the multimer include adducts, biurets, and nurates. The aliphatic isocyanate-based compound is an isocyanate having an aliphatic group and having no aromatic ring, the alicyclic isocyanate-based compound is an isocyanate having an alicyclic hydrocarbon group, and the aromatic isocyanate-based compound is an isocyanate having an aromatic ring. Since the surface coating layer 6 is formed of polyurethane, excellent electrolytic solution resistance is imparted to the exterior material for electrical storage devices.

If necessary, the surface coating layer 6 may contain additives such as the slipping agent, an anti-blocking agent, a matting agent, a flame retardant, an antioxidant, a tackifier and an anti-static agent on the surface of the surface coating layer 6 and/or inside the surface coating layer 6 according to the functionality and the like to be imparted to the surface coating layer 6 and the surface thereof. The additives are in the form of, for example, fine particles having an average particle diameter of about 0.5 nm to 5 μm. The average particle diameter of the additives is a median diameter measured by a laser diffraction/scattering particle size distribution measuring apparatus.

The additives may be either inorganic substances or organic substances. The shape of the additive is not particularly limited, and examples thereof include a spherical shape, a fibrous shape, a plate shape, an amorphous shape and a scaly shape.

Specific examples of the additives include talc, silica, graphite, kaolin, montmorillonite, mica, hydrotalcite, silica gel, zeolite, aluminum hydroxide, magnesium hydroxide, zinc oxide, magnesium oxide, aluminum oxide, neodymium oxide, antimony oxide, titanium oxide, cerium oxide, calcium sulfate, barium sulfate, calcium carbonate, calcium silicate, lithium carbonate, calcium benzoate, calcium oxalate, magnesium stearate, alumina, carbon black, carbon nanotubes, high-melting-point nylons, acrylate resins, crosslinked acryl, crosslinked styrene, crosslinked polyethylene, benzoguanamine, gold, aluminum, copper and nickel. The additives may be used alone, or may be used in combination of two or more thereof. Of these additives, silica, barium sulfate and titanium oxide are preferable from the viewpoint of dispersion stability, costs, and so on. The surface of the additive may be subjected to various kinds of surface treatments such as insulation treatment and dispersibility enhancing treatment.

The method for forming the surface coating layer 6 is not particularly limited, and examples thereof include a method in which a resin for forming the surface coating layer 6 is applied. When the additive is added to the surface coating layer 6, a resin mixed with the additive may be applied.

The thickness of the surface coating layer 6 is not particularly limited as long as the above-mentioned function as the surface coating layer 6 is performed, and it is, for example, about 0.5 to 10 μm, preferably about 1 to 5 μm.

### 3. Method for Manufacturing Exterior Material for Electrical Storage Devices

The method for manufacturing an exterior material for electrical storage devices is not particularly limited as long as a laminate is obtained in which the layers of the exterior material for electrical storage devices according to the present disclosure are laminated. Examples thereof include a method including the step of laminating at least the base material layer 1, the adhesive agent layer 2, the barrier layer 3 and the heat-sealable resin layer 4 in this order. That is, the method for manufacturing an exterior material for electrical storage devices according to the present disclosure includes the step of laminating at least a base material layer, an adhesive agent layer, a barrier layer and a heat-sealable resin layer in this order to obtain a laminate, the base material layer including a polyamide layer, the polyamide layer having a heat shrinkage ratio of 2.5% or less at 180° C. in a machine direction, the adhesive agent layer having a glass transition temperature (Tg) of 100° C. or higher and 139° C. or lower.

An example of the method for manufacturing the exterior material for electrical storage devices of the present invention is as follows. First, a laminate including the base material layer 1, the adhesive agent layer 2 and the barrier layer 3 in this order (hereinafter, the laminate may be described as a “laminate A”) is formed. Specifically, the laminate A can be formed by a dry lamination method in which an adhesive to be used for formation of the adhesive agent layer 2 is applied onto the base material layer 1 or the barrier layer 3, the surface of which is subjected to a chemical conversion treatment if necessary, using a coating method such as a gravure coating method or a roll coating method, and dried, the barrier layer 3 or the base material layer 1 is then laminated, and the adhesive agent layer 2 is cured.

Then, the heat-sealable resin layer 4 is laminated on the barrier layer 3 of the laminate A. When the heat-sealable resin layer 4 is laminated directly on the barrier layer 3, the heat-sealable resin layer 4 may be laminated onto the barrier layer 3 of the laminate A by a method such as a thermal lamination method or an extrusion lamination method. When the adhesive layer 5 is provided between the barrier layer 3 and the heat-sealable resin layer 4, the layers may be laminated by a method such as a co-extrusion lamination method, a tandem lamination method, a thermal lamination method, a sandwich lamination method, or a dry lamination method. Specifically, mention is made of, for example, (1) a method in which the adhesive layer 5 and the heat-sealable resin layer 4 are extruded to be laminated on the barrier layer 3 of the laminate A (extrusion lamination method or tandem lamination method); (2) a method in which the adhesive layer 5 and the heat-sealable resin layer 4 are laminated to form a laminate separately, and the laminate is laminated on the barrier layer 3 of the laminate A by a thermal lamination method, or a method in which a laminate with the adhesive layer 5 laminated on the barrier layer 3 of the laminate A is formed, and laminated to the heat-sealable resin layer 4 by a thermal lamination method; (3) a method in which the melted adhesive layer 5 is poured between the barrier layer 3 of the laminate A and the heat-sealable resin layer 4 formed in a sheet shape beforehand, and simultaneously the laminate A and the heat-sealable resin layer 4 are bonded to each other with the adhesive layer 5 interposed therebetween (sandwich lamination); and (4) an adhesive for forming the adhesive layer 5 is applied by solution coating and dried or baked to laminate the adhesive on the barrier layer 3 of the laminate A, and the heat-sealable resin layer 4 formed in a sheet shape in advance is laminated on the adhesive layer 5.

When the surface coating layer 6 is provided, the surface coating layer 6 is laminated on a surface of the base material layer 1 on a side opposite to the barrier layer 3. The surface coating layer 6 can be formed by, for example, coating a surface of the base material layer 1 with the resin that forms the surface coating layer 6. The order of the step of laminating the barrier layer 3 on a surface of the base material layer 1 and the step of laminating the surface coating layer 6 on a surface of the base material layer 1 is not particularly limited. For example, the surface coating layer 6 may be formed on a surface of the base material layer 1, followed by forming the barrier layer 3 on a surface of the base material layer 1 on a side opposite to the surface coating layer 6.

As described above, a laminate including the surface coating layer 6 provided if necessary, the base material layer 1, the adhesive agent layer 2, the barrier layer 3, the adhesive layer 5 provided if necessary, and the heat-sealable resin layer 4 in this order is formed, and the laminate may be further subjected to a heating treatment for strengthening the bondability of the adhesive agent layer 2 and the adhesive layer 5 provided if necessary.

In the exterior material for electrical storage devices, the layers forming the laminate may be subjected to surface activation treatment such as corona treatment, blast treatment, oxidation treatment or ozone treatment if necessary to improve processing suitability. For example, by subjecting a surface of the base material layer 1, which is opposite to the barrier layer 3, to a corona treatment, the ink printability of the surface of the base material layer 1 can be improved.

### 4. Uses of Exterior Material for Electrical Storage Devices

The exterior material for electrical storage devices according to the present disclosure is used as a packaging for hermetically sealing and storing electrical storage device elements such as a positive electrode, a negative electrode, and an electrolyte. That is, in a packaging formed of the exterior material for electrical storage devices of the present disclosure, an electrical storage device element including at least a positive electrode, a negative electrode, and an electrolyte can be housed to obtain an electrical storage device.

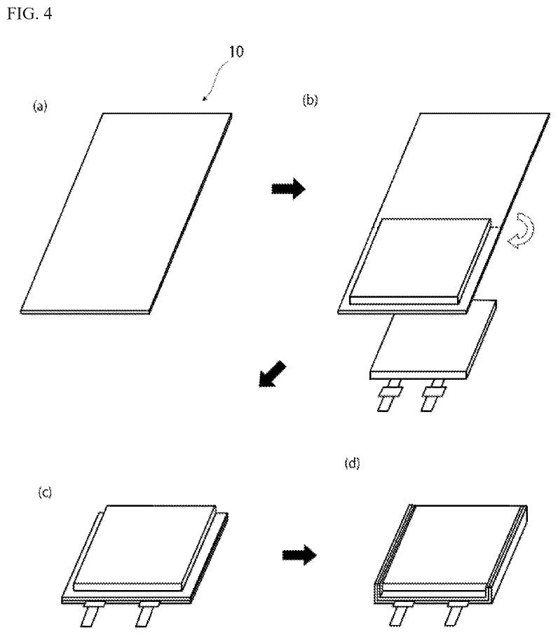

Specifically, an electrical storage device element including at least a positive electrode, a negative electrode, and an electrolyte is covered with the exterior material for electrical storage devices according to the present disclosure such that a flange portion (region where a heat-sealable resin layer is in contact with itself) can be formed on the periphery of the electrical storage device element while a metal terminal connected to each of the positive electrode and the negative electrode protrudes to the outside, and the heat-sealable resin layer at the flange portion is heat-sealed with itself, thereby providing an electrical storage device using the exterior material for electrical storage devices. When the electrical storage device element is stored in the packaging formed of the exterior material for electrical storage devices according to the present disclosure, the packaging is formed in such a manner that the heat-sealable resin portion of the exterior material for electrical storage devices according to the present disclosure is on the inner side (a surface contacting the electrical storage device element). The heat-sealable resin layers of two exterior materials for electrical storage devices may be superposed in such a manner as to face each other, followed by heat-sealing the peripheral edge portions of the superposed exterior materials for electrical storage devices to form a packaging. Alternatively, as in the example shown in FIG. 4, one exterior material for electrical storage devices may be folded over itself, followed by heat-sealing the peripheral edge portions to form a packaging. When the exterior material is folded over itself, a packaging may be formed by three-side sealing with the exterior material heat-sealed at sides other than the folding side as in the example shown in FIG. 4, or may be subjected to four-side sealing with the exterior material folded in such a manner that a flange portion can be formed, or the exterior material for electrical storage devices may be wound around the periphery of the electrical storage device element, with the heat-sealable resin layers being sealed to form a heat-sealed portion, followed by disposition of a lid such that openings at both ends are each closed. In the exterior material for electrical storage devices, a concave portion for housing an electrical storage device element may be formed by deep drawing molding or bulging molding. As in the example shown in FIG. 4, one exterior material for electrical storage devices may be provided with a concave portion while the other exterior material for electrical storage devices is not provided a concave portion, or the other exterior material for electrical storage devices may also be provided with a concave portion.

The exterior material for electrical storage devices according to the present disclosure can be suitably used for electrical storage devices such as batteries (including condensers, capacitors and the like). The exterior material for electrical storage devices according to the present disclosure may be used for either primary batteries or secondary batteries, and is preferably used for secondary batteries. The type of secondary battery to which the exterior material for electrical storage devices according to the present disclosure is applied is not particularly limited, and examples thereof include lithium ion batteries, lithium ion polymer batteries, all-solid-state batteries, semi-solid-state batteries, pseudo-solid-state batteries, polymer batteries, all polymer batteries, lead storage batteries, nickel-hydrogen storage batteries, nickel-cadmium storage batteries, nickel-iron storage batteries, nickel-zinc storage batteries, silver oxide-zinc storage batteries, metal-air batteries, polyvalent cation batteries, condensers and capacitors. Of these secondary batteries, preferred subjects to which the exterior material for electrical storage devices according to the present disclosure is applied include lithium ion batteries and lithium ion polymer batteries.

### EXAMPLES

Hereinafter, the present disclosure will be described in detail by way of examples and comparative examples. However, the present disclosure is not limited to examples.

### <Manufacturing of Exterior Material for Electrical Storage Devices>

### Examples 1 to 5 and Comparative Examples 1 to 4

For a base material layer, a stretched polyethylene terephthalate (PET) film (thickness: 12 μm) and a stretched nylon (ONy) film (thickness: 15 μm) were prepared. The stretched nylon film forms a polyamide layer of the base material layer. The heat shrinkage ratios (MD and TD) of the stretched nylon films at 180° C. are as shown in Table 1. The heat shrinkage ratios (MD and TD) at 180° C. of the stretched nylon films were adjusted mainly by a draw ratio in manufacturing of a biaxially stretched nylon film. Next, the PET film and the ONy film were bonded using an adhesive. Specifically, using a two-liquid polyurethane adhesive (glass transition temperature after curing: 115° C.) with a polyester polyol and an aromatic isocyanate-based compound, the PET film and the ONy film were bonded to each other with an adhesive agent layer interposed therebetween in such a manner that the adhesive agent layer (DL: formed by a dry lamination method) had a thickness of 3 μm after curing. In addition, an aluminum foil (JIS H4160: 1994 A8021 H-O (thickness: 40 μm)) was prepared as a barrier layer. Next, using a two-liquid polyurethane adhesive (glass transition temperature after curing: 115° C.) with a polyester polyol and an aromatic isocyanate-based compound again, the aluminum foil and the base material layer (ONy film side) were laminated by a dry lamination method in such a manner that the thickness of the adhesive agent layer after curing was 3 μm, and aging treatment was then performed to produce a laminate of base material layer/adhesive agent layer/barrier layer. Both surfaces of the aluminum foil are subjected to chemical conversion treatment. The chemical conversion treatment of the aluminum foil was performed by applying to both the surfaces of the aluminum foil a treatment liquid including a phenol resin, a chromium fluoride compound and phosphoric acid using a roll coating method in such a manner that the application amount of chromium was 10 mg/m² (dry mass), and performing baking.

Next, maleic anhydride-modified polypropylene as an adhesive layer and random polypropylene as a first heat-sealable resin layer were melted and co-extruded onto the barrier layer of each of the obtained laminates to laminate the adhesive layer (thickness: 40 μm) and the heat-sealable resin layer (thickness: 40 μm) on the barrier layer, thereby obtaining an exterior material for electrical storage devices in which a base material layer (PET/adhesive agent layer/ONy), an adhesive agent layer, a barrier layer, an adhesive layer and a heat-sealable resin layer were laminated in this order.

### Example 6 and Comparative Example 5

A stretched nylon (ONy) film (thickness: 25 μm) was provided as a base material layer. The stretched nylon film forms a polyamide layer of the base material layer. The heat shrinkage ratios (MD and TD) of the stretched nylon films at 180° C. are as shown in Table 2. The heat shrinkage ratios (MD and TD) at 180° C. of the stretched nylon films were adjusted mainly by a draw ratio in manufacturing of a biaxially stretched nylon film. Next, an aluminum foil (JIS H4160: 1994 A8021 H-O (thickness: 40 μm)) was prepared as a barrier layer. Next, using a two-liquid polyurethane adhesive (glass transition temperature after curing: 115° C.) with a polyester polyol and an aromatic isocyanate-based compound, the aluminum foil and a base material were laminated by a dry lamination method in such a manner that the thickness of the adhesive agent layer after curing was 3 μm, and aging treatment was then performed to produce a laminate of base material layer/adhesive agent layer/barrier layer. Both surfaces of the aluminum foil are subjected to chemical conversion treatment. The chemical conversion treatment of the aluminum foil was performed by applying to both the surfaces of the aluminum foil a treatment liquid including a phenol resin, a chromium fluoride compound and phosphoric acid using a roll coating method in such a manner that the application amount of chromium was 10 mg/m² (dry mass), and performing baking.

Next, maleic anhydride-modified polypropylene as an adhesive layer and random polypropylene as a first heat-sealable resin layer were melted and co-extruded onto the barrier layer of each of the obtained laminates to laminate the adhesive layer (thickness: 22.5 μm) and the heat-sealable resin layer (thickness: 22.5 μm) on the barrier layer, thereby obtaining an exterior material for electrical storage devices in which a base material layer (ONy), an adhesive agent layer, a barrier layer, an adhesive layer and a heat-sealable resin layer were laminated in this order.

### <Heat Shrinkage Ratio of Polyamide Layer at 180° C.>

Each of the stretched nylon films forming the polyamide layer of the base material layer was cut into a size of 10 cm in the machine direction (MD)×10 cm in the transverse direction (TD) to obtain a test piece. The test piece was heated in an oven at 180° C. for 30 minutes, and the size change ratio of the test piece in each of the machine direction (MD) and the transverse direction (TD) (two directions orthogonal to each other) before and after heating was taken as a heat shrinkage ratio at 180° C., and determined from the following equation. Tables 1 and 2 show the results.

$$Heat shrinkage ratio ( size change ratio ) at 180 ° C . = [ ( X - Y ) / X ] \times 100$$

X is a size before heating in the oven, and Y is a size after heating in the oven.

For the purpose of reference, the hot water shrinkage ratio in Example 1 was measured, and the result showed that the hot water shrinkage ratio in the machine direction was 1.2%, and the hot water shrinkage ratio in the transverse direction was 2.1%. The hot water shrinkage ratio is a value measured in the same manner as in the case of the above-described heat shrinkage ratio at 180° C. except that the size change ratio in immersion of the test piece in hot water at 95° C. for 30 minutes was measured.

### <Glass Transition Temperature (Tg) of Adhesive Agent Layer>

The glass transition temperature (Tg) of the adhesive agent layer is a value measured using a rigid body pendulum-type viscoelasticity measuring apparatus (model: RPT-3000W manufactured by A&D Company, Limited). The measurement conditions were as follows: pipe: RBP-080 (8 mmφ pipe), frame: FRB-100, measurement temperature: the sample is heated from room temperature (25° C.) to 30° C. at a temperature rise rate of 6° C./min, held at 30° C. for 5 minutes, and heated to 180° C. at a temperature rise rate of 3° C./min, adsorption time: 1 second, and measurement interval: 10 seconds. The adhesive agent layer was peeled from the polyamide layer of the exterior material for electrical storage devices, and used for measurement. Specifically, the polyamide layer and the barrier layer were peeled from each other, and with the adhesive agent layer attached on the polyamide layer, the glass transition temperature of the adhesive agent layer was measured.

### <Laminate Strength Between Polyamide Layer and Barrier Layer (Environment at 25° C. and 120° C.)>

As specified in JIS K 7127:1999, the lamination strength of the exterior material for electrical storage devices at each of temperatures shown in Tables 1 and 2 (room temperature (25° C.) or 120° C.) was measured as follows. From each exterior material for electrical storage devices, a test sample was cut into a strip shape having a width of 15 mm (transverse direction) and a length of 150 mm (machine direction). The MD of the exterior material for electrical storage devices corresponds to the rolling direction (RD) of the aluminum alloy foil, the TD of the exterior material for electrical storage devices corresponds to the TD of the aluminum alloy foil. Next, at a short-side portion of the test sample on one side thereof, the test sample was delaminated at the interface between the adhesive agent layer and the barrier layer to the extent that it was possible to grip the test sample with a gripping tool of a tensile tester (AG-X plus (trade name) manufactured by Shimadzu Corporation) on each of a side where the base material layer was present and a side where the barrier layer was present, thereby obtaining a measuring test sample. Next, the measuring test sample was attached to the tensile tester and left to stand at each measurement temperature for 2 minutes, and subsequently, the lamination strength (N/15 mm) between the base material layer and the barrier layer was measured by the tensile tester under the conditions of peeling by 180°, a tensile speed of 50 mm/min, and a gauge length of 50 mm. The strength at a gauge length of 57 mm was taken as a lamination strength (N/15 mm). The average of values obtained by measuring the lamination strength (N/15 mm) three times is shown as a lamination strength in Tables 1 and 2.

### <Warpage Height>

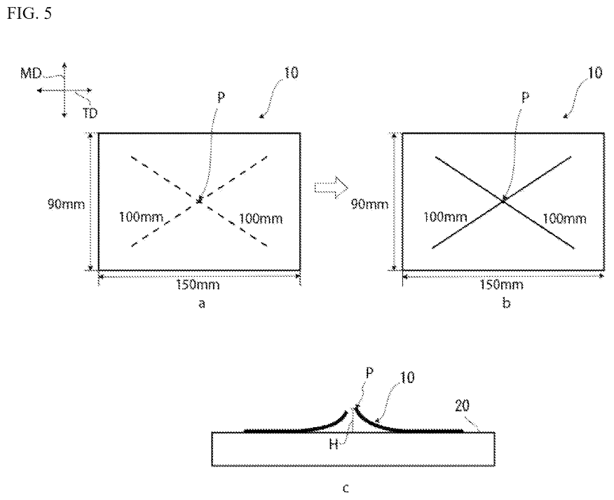

Each exterior material for electrical storage devices was cut into a rectangle having a length of 90 mm (machine direction) and a width of 150 mm (transverse direction). The exterior material for electrical storage devices is cut at a broken line portion in FIG. 5a, and used as a warpage measurement sample. The blade of the cutter corresponds to the rectangular shape of the sample, and further, a blade is provided so as to make two 100 mm-long cuts on a diagonal line extending through the center portion P of sample. Using a cutter, the battery packaging material is cut once from the heat-sealable resin layer side to produce a sample provided with a cut as shown in FIG. 5b. The cut extends in the thickness direction of the sample. Next, the sample was stored in a dry room for 24 hours. Next, the sample is taken out from the dry room, and placed on a horizontal plane 20 with the base material layer on the upper side, and only the peripheral edge portion (about 10 mm in width) of the sample is pressed against the horizontal plane 20, so that the cut is convexly warped, and the height of the center portion P becomes greater than that of the horizontal surface 20. Here, the shortest distance between the horizontal plane 20 and the center portion P (warpage height) is measured with a ruler (FIG. 5c). The warpage of a portion having a greater warpage height H, of two portions warped in the transverse direction (TD), among four convexly warped portions, was defined as warpage in the transverse direction. Similarly, the warpage of a portion having a greater warpage height H, of two portions warped in the machine direction (MD), among four convexly warped portions, was defined as warpage in the machine direction. Since among four convexly warped portions, convex portions warped in the transverse direction (TD) are larger than convex portions warped in the machine direction (MD), the warpage in the transverse direction is relatively larger than the warpage in the machine direction.

### <Moldability>

For each of the exterior materials for electrical storage devices, a test sample in which erucic acid amide was applied as a slipping agent to each of both surfaces (the surface of the base material layer and the surface of the heat-sealable resin layer) of the exterior material for electrical storage devices (with slipping agent) was prepared, and subjected to cold molding under the following conditions. First, each exterior material for electrical storage devices was cut to a rectangle having a length of 90 mm (machine direction) and a width of 150 mm (transverse direction) to obtain a test sample. The MD of the exterior material for electrical storage devices corresponds to the rolling direction (RD) of the aluminum alloy foil, the TD of the exterior material for electrical storage devices corresponds to the TD of the aluminum alloy foil. Next, using a rectangular mold having an opening size of 31.6 mm (machine direction)×54.5 mm (transverse direction) (female; the surface has a roughness in maximum height (nominal value of Rz) of 3.2 μm as specified in Appendix 1 (Reference) of JIS B 0659-1:2002, Comparative Surface Roughness Standard Specimen, Table 2; the curvature radius R of the corner is 2.0 mm; and the curvature radius R of the ridge line is 1.0 mm), and a corresponding mold (male; surface of the ridge line portion has a roughness in maximum height (nominal value of Rz) of 1.6 μm as specified in Appendix 1 (Reference) of JIS B 0659-1:2002, Comparative Surface Roughness Standard Specimen, Table 2; the surface of a non-ridge line portion has a roughness in maximum height (nominal value of Rz) of 3.2 μm as specified in Appendix 1 (Reference) of JIS B 0659-1:2002, Comparative Surface Roughness Standard Specimen, Table 2; the curvature radius R of the corner is 2.0 mm; and the curvature radius R of the ridge line is 1.0 mm), each sample was subjected to cold molding (draw molding in one stage) at each molding depth (from 5.0 mm up to 8.5 mm with an interval of 0.5 mm) under a pressing pressure (surface pressure) of 0.25 MPa in an environment at 25° C. This procedure is carried out for 10 test samples. At this time, the molding was performed at room temperature (25° C.) with the test sample placed on the female mold in such a manner that the heat-sealable resin layer was located on the male mold side. The male mold and the female mold had a clearance of 0.3 mm. For the test sample after cold molding, light was applied with a penlight in a dark room, and whether or not pinholes or cracks were generated in the aluminum alloy foil was checked on the basis of transmission of light. For the cold-molded exterior material for electrical storage devices, the deepest of depths at which none of the 10 test samples had pinholes and cracks in the aluminum alloy foil is defined as A mm, and the number of test samples having pinholes etc. at the shallowest of depths where pinholes etc. were generated in the aluminum alloy foil was defined as B. The value calculated from the following equation was rounded off to one decimal place, and the resulting value was defined as a limit molding depth of the exterior material for electrical storage devices. Tables 1 and 2 show the results.

Limit molding depth=A mm+(0.5 mm/10 pieces)×(10 pieces−B pieces)

TABLE 1

| | | | Exam- | Exam- | Exam- | Exam- | Exam- | Comparative | Comparative | Comparative | Comparative |
|---|---|---|---|---|---|---|---|---|---|---|---|
| | | | ple 1 | ple 2 | ple 3 | ple 4 | ple 5 | Example 1 | Example 2 | Example 3 | Example 4 |
| Heat shrinkage ratio of | | MD | 2.7 | 2.7 | 2.7 | 2.7 | 2.7 | 2.7 | 2.7 | 2.7 | 2.7 |
| PET layer at 180° C. (%) | | TD | 0.9 | 0.9 | 0.9 | 0.9 | 0.9 | 0.9 | 0.9 | 0.9 | 0.9 |
| Heat shrinkage ratio of | | MD | 1.5 | 1.2 | 2.2 | 1.2 | 1.7 | 4.0 | 2.6 | 3.2 | 3.1 |
| polyamide layer at 180° C. (%) | | TD | 2.9 | 1.1 | 2.4 | 2.1 | 0.7 | 4.7 | 1.9 | 1.7 | 2.0 |
| Glass transition temperature (Tg) | | | 115 | 115 | 115 | 115 | 115 | 115 | 115 | 115 | 115 |
| of adhesive agent layer (° C.) | | | | | | | | | | | |
| Exterior | Lamination strength | 25° C. | 8.5 | 8.6 | 8.1 | 7.4 | 8.8 | 8.1 | 8.2 | 7.4 | 9.1 |
| material | between polyamide | 120° C. | 4.9 | 4.5 | 4.6 | 4.0 | 4.7 | 3.6 | 3.8 | 3.8 | 3.7 |
| for | layer and barrier | | | | | | | | | | |
| electrical | layer (N) | | | | | | | | | | |
| storage | Warpage height (mm) | MD | 1.2 | 1.0 | 1.4 | 1.0 | 1.0 | 3.0 | 2.5 | 27 | 2.5 |
| devices | | TD | 18.1 | 19.1 | 22.3 | 18.5 | 12.0 | 35.0 | 28.1 | 29.2 | 24.0 |

| | | | | | | | | | |
|---|---|---|---|---|---|---|---|---|---|
| Moldability (mm) | 7.2 | 7.1 | 7.4 | 7.4 | 7.1 | 7.4 | 7.4 | 7.6 | 6.9 |

The exterior material for electrical storage devices in each of Examples 1 to 5 includes a laminate including at least a base material layer, an adhesive agent layer, a barrier layer and a heat-sealable resin layer in this order, the base material layer including a polyamide layer, the polyamide layer having a heat shrinkage ratio of 2.5% or less at 180° C. in a machine direction, the adhesive agent layer having a glass transition temperature (Tg) of 100° C. or higher and 139° C. or lower. In the exterior material for electrical storage devices in each of Examples 1 to 5, delamination between the polyamide layer and the barrier layer in the case of placement in a high-temperature environment (at about 120° C.) is suppressed, and warpage due to cutting is suppressed. More specifically, comparison of the exterior materials for electrical storage devices in Examples 1 to 5 with the exterior materials for electrical storage devices in Comparative Examples 1 to 4 show that the glass transition temperatures of the adhesive agent layers are all set within the predetermined range, and the polyamide layers have different heat shrinkage ratios at 180° C. in MD, but there is no connection between the heat shrinkage ratio of the polyamide layer at 180° C. in MD and the lamination strength at room temperature (25° C.). However, it can be seen that the exterior materials for electrical storage devices in Examples 1 to 5, in which the heat shrinkage ratio of the polyamide layer at 180° C. in MD is set to 2.5% or less, have high lamination strength in a high-temperature environment at 120° C., and hardly undergo warpage. From these results, it can be seen that when the glass transition temperature of the adhesive agent layer is set within a predetermined range, and the heat shrinkage ratio of the polyamide layer at 180° C. in MD is set to be equal to or smaller than a predetermined value, delamination between the polyamide layer and the barrier layer in the case of placement in a high-temperature environment (at about 120° C.) is suppressed, and warpage due to cutting is suppressed, so that productivity of the exterior material for electrical storage devices is improved.

TABLE 2

| | | | Exam- | Comparative |
|---|---|---|---|---|
| | | | ple 6 | Example 5 |
| Heat shrinkage ratio of | | MD | 2.2 | 4.0 |
| polyamide layer at 180° C. (%) | | TD | 2.4 | 4.7 |
| Glass transition temperature (Tg) of | | | 115 | 115 |
| adhesive agent layer (° C.) | | | | |
| Exterior | Lamination strength | 25° C. | 6.0 | 5.7 |
| material | between polyamide | 120° C. | 3.8 | 3.4 |
| for | layer and barrier | | | |
| electrical | layer (N) | | | |
| storage | Warpage height | MD | 0.5 | 1.0 |
| devices | (mm) | TD | 26.8 | 30.0 |
| | Moldability (mm) | | 8.5 | 8.5 |

The exterior material for electrical storage devices in Example 6 also includes a laminate including at least a base material layer, an adhesive agent layer, a barrier layer and a heat-sealable resin layer in this order, the base material layer including a polyamide layer, the polyamide layer having a heat shrinkage ratio of 2.5% or less at 180° C. in a machine direction, the adhesive agent layer having a glass transition temperature (Tg) of 100° C. or higher and 139° C. or lower. In the exterior material for electrical storage devices in Example 6, delamination between the polyamide layer and the barrier layer in the case of placement in a high-temperature environment (at about 120° C.) is suppressed, and warpage due to cutting is suppressed. More specifically, comparison between the exterior materials for electrical storage devices in Example 6 and Comparative Example 5 show that the glass transition temperatures of the adhesive agent layers are all set within the predetermined range, and the polyamide layers have different heat shrinkage ratios at 180° C. in MD, but there is no connection between the heat shrinkage ratio of the polyamide layer at 180° C. in MD and the lamination strength at room temperature (25° C.). However, it can be seen that the exterior material for electrical storage devices in Example 6, in which the heat shrinkage ratio of the polyamide layer at 180° C. in MD is set to 2.5% or less, has high lamination strength in a high-temperature environment at 120° C., and hardly undergoes warpage, as compared to Comparative Example 5. From these results, it can be seen that when the glass transition temperature of the adhesive agent layer is set within a predetermined range, and the heat shrinkage ratio of the polyamide layer at 180° C. in MD is set to be equal to or smaller than a predetermined value, delamination between the polyamide layer and the barrier layer in the case of placement in a high-temperature environment (at about 120° C.) is suppressed, and warpage due to cutting is suppressed, so that productivity of the exterior material for electrical storage devices is improved.

As described above, the present disclosure provides the invention of aspects as shown below.

Item 1. An exterior material for electrical storage devices, including a laminate including at least a base material layer, an adhesive agent layer, a barrier layer and a heat-sealable resin layer in this order,
the base material layer including a polyamide layer,
the polyamide layer having a heat shrinkage ratio of 2.5% or less at 180° C. in a machine direction,
the adhesive agent layer having a glass transition temperature (Tg) of 100° C. or higher and 139° C. or lower.

Item 2. The exterior material for electrical storage devices according to item 1, in which the polyamide layer has a heat shrinkage ratio of 1.9% or less at 180° C. in the machine direction.

Item 3. The exterior material for electrical storage devices according to item 1, in which the polyamide layer has a heat shrinkage ratio of 1.4% or less at 180° C. in the machine direction.

Item 4. The exterior material for electrical storage devices according to any one of items 1 to 3, in which the base material layer further includes a polyester layer.

Item 5. The exterior material for electrical storage devices according to any one of items 1 to 4, further including an adhesive layer between the barrier layer and the heat-sealable resin layer.

Item 6. The exterior material for electrical storage devices according to any one of items 1 to 5, in which a thickness of the laminate is 155 μm or more and 190 μm or less.

Item 7. The exterior material for electrical storage devices according to any one of items 1 to 6, in which two or more slipping agents are present on a surface of the base material layer and/or inside the base material layer.

Item 8. The exterior material for electrical storage devices according to any one of items 1 to 7, in which a thickness of the base material layer is 35 μm or less, or 35 μm or more.

Item 9. The exterior material for electrical storage devices according to any one of items 1 to 8, in which the barrier layer contains at least one of an aluminum alloy foil and a stainless steel foil.

Item 10. The exterior material for electrical storage devices according to any one of items 1 to 9, in which a thickness of the barrier layer is 50 μm or less, or 45 μm or more.

Item 11. The exterior material for electrical storage devices according to any one of items 1 to 10, in which a slipping agent is present on a surface of the heat-sealable resin layer, and an amount of the slipping agent is 10 mg/m² or more.

Item 12. The exterior material for electrical storage devices according to any one of items 1 to 11, in which a resin containing a polyolefin backbone forms the heat-sealable resin layer.

Item 13. The exterior material for electrical storage devices according to any one of items 1 to 12, in which the heat-sealable resin layer contains at least one selected from the group consisting of a polyolefin, a cyclic polyolefin, an acid-modified polyolefin and an acid-modified cyclic polyolefin.

Item 14. The exterior material for electrical storage devices according to any one of items 1 to 13, in which the heat-sealable resin layer is formed of a blend polymer obtained by combining two or more resins.

Item 15. The exterior material for electrical storage devices according to item 1 or 2, in which the heat-sealable resin layer contains at least one selected from the group consisting of a polyolefin, a cyclic polyolefin, an acid-modified polyolefin and an acid-modified cyclic polyolefin, and the heat-sealable resin layer is formed of a blend polymer obtained by combining two or more resins.

Item 16. The exterior material for electrical storage devices according to any one of items 1 to 15, in which the heat-sealable resin layer has two or more layers formed of the same resin or different resins.

Item 17. The exterior material for electrical storage devices according to any one of items 1 to 16, in which two or more slipping agents are present on a surface of the heat-sealable resin layer and/or inside the heat-sealable resin layer.

Item 18. The exterior material for electrical storage devices according to any one of items 1 to 17, in which at least two selected from the group consisting of a saturated fatty acid amide, an unsaturated fatty acid amide, a substituted amide, a methylol amide, a saturated fatty acid bisamide, an unsaturated fatty acid bisamide, a fatty acid ester amide and an aromatic bisamide are present on a surface of the heat-sealable resin layer and/or inside the heat-sealable resin layer.

Item 19. A method for manufacturing an exterior material for electrical storage devices, including the step of laminating at least a base material layer, an adhesive agent layer, a barrier layer and a heat-sealable resin layer in this order to obtain a laminate,
the base material layer including a polyamide layer,
the polyamide layer having a heat shrinkage ratio of 2.5% or less at 180° C. in a machine direction,
the adhesive agent layer having a glass transition temperature (Tg) of 100° C. or higher and 139° C. or lower.

Item 20. The method for manufacturing an exterior material for electrical storage devices according to item 19, in which an adhesive layer is provided between the barrier layer and the heat-sealable resin layer, and
the adhesive layer and the heat-sealable resin layer are laminated by a co-extrusion lamination method, a tandem lamination method, a thermal lamination method, a sandwich lamination method, or a dry lamination method.

Item 21. The method for manufacturing an exterior material for electrical storage devices according to item 19 or 20, in which an adhesive layer is provided between the barrier layer and the heat-sealable resin layer, and
the heat-sealable resin layer has two or more layers formed of the same resin or different resins.

Item 22. An electrical storage device in which an electrical storage device element including at least a positive electrode, a negative electrode and an electrolyte is housed in a packaging formed of the exterior material for electrical storage devices according to any one of items 1 to 18.

### DESCRIPTION OF REFERENCE SIGNS

1: Base material layer
2: Adhesive agent layer
3: Barrier layer
4: Heat-sealable resin layer
5: Adhesive layer
6: Surface coating layer
10: Exterior material for electrical storage devices
20: Horizontal plane

1. An exterior material for electrical storage devices, comprising a laminate including at least a base material layer, an adhesive agent layer, a barrier layer and a heat-sealable resin layer in this order,
wherein the base material layer including a polyamide layer,
the polyamide layer having a heat shrinkage ratio of 2.5% or less at 180° C. in a machine direction, and
the adhesive agent layer having a glass transition temperature (Tg) of 100° C. or higher and 139° C. or lower.

2. The exterior material for electrical storage devices according to claim 1, wherein the polyamide layer has a heat shrinkage ratio of 1.9% or less at 180° C. in the machine direction.

3. The exterior material for electrical storage devices according to claim 1, wherein the polyamide layer has a heat shrinkage ratio of 1.4% or less at 180° C. in the machine direction.

4. The exterior material for electrical storage devices according to claim 1, wherein the base material layer further includes a polyester layer.

5. The exterior material for electrical storage devices according to claim 1, further comprising an adhesive layer between the barrier layer and the heat-sealable resin layer.

6. The exterior material for electrical storage devices according to claim 1, wherein a thickness of the laminate is 155 μm or more and 190 μm or less.

7. The exterior material for electrical storage devices according to claim 1, wherein two or more slipping agents are present on a surface of the base material layer and/or inside the base material layer.

8. The exterior material for electrical storage devices according to claim 1, wherein a thickness of the base material layer is 35 μm or less.

9. The exterior material for electrical storage devices according to claim 1, wherein the barrier layer contains at least one of an aluminum alloy foil and a stainless steel foil.

10. The exterior material for electrical storage devices according to claim 1, wherein a thickness of the barrier layer is 50 μm or less.

11. The exterior material for electrical storage devices according to claim 1, wherein a slipping agent is present on a surface of the heat-sealable resin layer, and an amount of the slipping agent is 10 mg/m² or more.

12. The exterior material for electrical storage devices according to claim 1, wherein a resin containing a polyolefin backbone forms the heat-sealable resin layer.

13. The exterior material for electrical storage devices according to claim 1, wherein the heat-sealable resin layer contains at least one selected from the group consisting of a polyolefin, a cyclic polyolefin, an acid-modified polyolefin and an acid-modified cyclic polyolefin.

14. The exterior material for electrical storage devices according to claim 1, wherein the heat-sealable resin layer is formed of a blend polymer obtained by combining two or more resins.

15. The exterior material for electrical storage devices according to claim 1, wherein the heat-sealable resin layer contains at least one selected from the group consisting of a polyolefin, a cyclic polyolefin, an acid-modified polyolefin and an acid-modified cyclic polyolefin, and the heat-sealable resin layer is formed of a blend polymer obtained by combining two or more resins.

16. The exterior material for electrical storage devices according to claim 1, wherein the heat-sealable resin layer has two or more layers formed of the same resin or different resins.

17. The exterior material for electrical storage devices according to claim 1, wherein two or more slipping agents are present on a surface of the heat-sealable resin layer and/or inside the heat-sealable resin layer.

18. The exterior material for electrical storage devices according to claim 1, wherein at least two selected from the group consisting of a saturated fatty acid amide, an unsaturated fatty acid amide, a substituted amide, a methylol amide, a saturated fatty acid bisamide, an unsaturated fatty acid bisamide, a fatty acid ester amide and an aromatic bisamide are present on a surface of the heat-sealable resin layer and/or inside the heat-sealable resin layer.

19. A method for manufacturing an exterior material for electrical storage devices, comprising the step of laminating at least a base material layer, an adhesive agent layer, a barrier layer and a heat-sealable resin layer in this order to obtain a laminate,
wherein the base material layer including a polyamide layer,
the polyamide layer having a heat shrinkage ratio of 2.5% or less at 180° C. in a machine direction, and
the adhesive agent layer having a glass transition temperature (Tg) of 100° C. or higher and 139° C. or lower.

20. The method for manufacturing an exterior material for electrical storage devices according to claim 19, wherein
an adhesive layer is provided between the barrier layer and the heat-sealable resin layer, and
the adhesive layer and the heat-sealable resin layer are laminated by a co-extrusion lamination method, a tandem lamination method, a thermal lamination method, a sandwich lamination method, or a dry lamination method.

21. The method for manufacturing an exterior material for electrical storage devices according to claim 19, wherein
an adhesive layer is provided between the barrier layer and the heat-sealable resin layer, and
the heat-sealable resin layer has two or more layers formed of the same resin or different resins.

22. An electrical storage device in which an electrical storage device element including at least a positive electrode, a negative electrode and an electrolyte is housed in a packaging formed of the exterior material for electrical storage devices according to claim 1.

23. The exterior material for electrical storage devices according to claim 1, wherein a thickness of the base material layer is 35 μm or more.

24. The exterior material for electrical storage devices according to claim 1, wherein a thickness of the barrier layer is 45 μm or more.

25. The exterior material for electrical storage devices according to claim 1, wherein a thickness of the adhesive agent layer is 5 μm or more.

26. The exterior material for electrical storage devices according to claim 1, wherein a thickness of the adhesive agent layer is 5 μm or less.
